(19) United States
(12) Patent Application Publication
(10) Pub. No.: US 2024/0022988 A1
(43) Pub. Date: Jan. 18, 2024

(54) METHOD AND APPARATUS FOR CONDITIONAL RECONFIGURATION

(71) Applicant: FUJITSU LIMITED, Kawasaki-shi (JP)

(72) Inventors: Meiyi JIA, Beijing (CN); Su YI, Beijing (CN); Yang LU, Beijing (CN)

(73) Assignee: FUJITSU LIMITED, Kawasaki-shi (JP)

(21) Appl. No.: 18/374,067

(22) Filed: Sep. 28, 2023

Related U.S. Application Data
(63) Continuation of application No. PCT/CN2021/085140, filed on Apr. 1, 2021.

(51) Int. Cl. H04W 36/30; H04W 24/02; H04W 76/19

(52) U.S. Cl. CPC H04W 36/305; H04W 24/02; H04W 76/19

(57) ABSTRACT

An apparatus for conditional reconfiguration, applicable to at least one of a first IAB-node, a child IAB-node of the first IAB-node and a terminal equipment served by the first IAB-node or the child IAB-node, includes a memory, and a processor coupled to the memory and configured to select one of first cell(s) fulfilling conditional reconfiguration condition(s) from conditional reconfiguration candidate cells as a second cell, and initiate conditional reconfiguration execution on the second cell.

### CROSS-REFERENCE TO RELATED APPLICATION

This application is a continuation application of International Application PCT/CN2021/085140 filed on Apr. 1, 2021, and designated the U.S., the entire contents of which are incorporated herein by reference.

### TECHNICAL FIELD

This disclosure relates to the field of communication technologies.

### BACKGROUND

Integrated access and backhaul (IAB) ensures wireless relay in NG-RAN. A relay node, namely, an IAB-node, supports NR access and backhauling. The backhauling may include a single hop or multiple hops. An end point of network side NR backhauling, namely, an IAB-donor, refers to a gNB that supports additional functions of the IAB. The IAB-donor may also be referred to as an IAB-donor-node.

The IAB-node supports functions of a gNB-DU (distributed unit), i.e. an IAB-DU. The IAB-DU terminates an NR access interface to a terminal equipment and a next hop of IAB-node, and terminates an F1 protocol of a gNB-CU function on the IAB-donor. In addition, the IAB-node also supports a subset of terminal equipment functions (UE functions), namely, IAB-MT, which includes, for example, functions of a gNB-DU connected to another IAB-node or the IAB-donor, a gNB-CU (centralized unit) connected to the IAB-donor and a physical layer, layer 2 (L2), RRC (radio resource control) and NAS (non-access stratum) connected to a core network.

The IAB-node is connected to an IAB-donor via one or more hops. In topology, the IAB-donor is a root node, a neighboring node on the IAB-DU interface of the IAB-node is referred to as a descendant IAB-node, i.e. a descendant IAB-node, and a neighboring node on an IAB-MT interface is referred to as a parent node, i.e. a parent IAB-node.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Under an IAB architecture, in some cases, migration of IAB-nodes is needed. Migration of IAB-nodes may also be referred to as topology adaptation of IAB-nodes. For example, after measuring link quality, an IAB-node determines to migrate from an original path to a new path. The original path is referred to as a source path, the new path is referred to as a target path, and an IAB-node for migration is referred to as a migration IAB-node.

A scenario of the migration or topology adaptation of an IAB-node may include migration or topology adaptation within and between IAB-donor-CUs.

For the scenario of intra-IAB-donor-CU migration or topology adaptation of an IAB-node, both a source parent IAB-node and a target parent IAB-node are served by the same IAB-donor-CU. The target parent IAB-node may use an IAB-donor-DU different from that of the source parent IAB-node, and the source path and the target path may have common nodes.

Rel-17 eIAB supports inter-CU IAB migration. For a scenario of inter-IAB-donor-CU migration or topology adaptation of an IAB-node, the source parent IAB-node and the target parent IAB-node are served by different IAB-donor-CUs, and the target parent IAB-node uses an IAB-donor-DU different from that of the source parent IAB-node.

A network may configure some conditional reconfiguration candidate cells and a conditional reconfiguration condition for a terminal equipment and/or an IAB-MT of an IAB-node. The terminal equipment and/or the IAB-MT may be evaluated according to the reconfiguration condition, and when evaluation conditions are fulfilled, corresponding configurations are applied.

For the terminal equipment, specifically, in conditional reconfiguration, the network configures one or more candidate target special cells, i.e. conditional reconfiguration candidate cells, for the terminal equipment. The terminal equipment evaluates conditions of each configured candidate target special cell. The terminal equipment applies conditional reconfiguration of a target special cell in target special cells fulfilling associated execution conditions. The network provides configuration parameters for the target special cells in a ConditionalReconfiguration IE.

Based on a received ConditionalReconfiguration IE, the terminal equipment performs the following actions:
if ConditionalReconfiguration includes condReconfigToRemoveList: executing a conditional reconfiguration removal procedure; and
if ConditionalReconfiguration includes condReconfigToAddModList: executing conditional reconfiguration addition and/or modification.

In the embodiments of this disclosure, the conditional reconfiguration addition and/or modification includes that,
for each condReconfigId received in condReconfigToAddModList, the UE will,
if an entry matching condReconfigId exists in the condReconfigToAddModList in VarConditionalReconfig,
if the entry in condReconfigToAddModList includes a condExecutionCond, replace this entry with a value of the received condReconfigId;
if the entry in tcondReconfigToAddModList includes a condRRCReconfig, replace this entry with a value of the received condReconfigId;
otherwise, add a new entry to this condReconfigId in VarConditionalReconfig; and
perform conditional reconfiguration evaluation.

In the embodiment of this disclosure, the conditional reconfiguration evaluation includes that:
the terminal equipment will,
for each condReconfigId in VarConditionalReconfig,
consider that cells with physical cell identities (PCI) matching values indicated by ServingCellConfigCommon in reconfigurationWithSync in the received condRRCReconfig are applicable cells,
for each measld in measldList in VarMeasConfig indicated in condExecutionCond associated with condReconfigId,
if all measurements during corresponding time ToTrigger filtered by layer-3 defined in an applicable cell by an entry condition for an event with which condReconfigId is associated in VarConditionalReconfig, i.e. an event corresponding to condEventId(s) of corresponding condTriggerConfig in VarConditionalReconfig, are fulfilled, consider that an event with which measId is associated is fulfilled;
if all measurements during corresponding time ToTrigger filtered by layer-3 defined in an applicable cell by a departure condition for an event with which condReconfigId is associated in VarConditionalReconfig, i.e. an event corresponding to condEventld(s) of corresponding condTriggerConfig in VarConditionalReconfig, are fulfilled, consider that an event with which measId is associated is not fulfilled;
if for a target candidate cell in the stored condRRCReconfig, events with which all measld(s) in condTriggerConfig are associated are fulfilled:
consider that the target candidate cell in the stored condRRCReconfig with which condReconfigId is associated is a triggered cell;
initiate conditional reconfiguration execution.

The conditional reconfiguration execution includes that:
the terminal equipment will:
if there exists a triggered cell, select a triggered cell as a selected cell for conditional reconfiguration execution;
and for the selected cell for conditional reconfiguration execution, apply stored condRRCReconfig of the selected cell. The conditional reconfiguration may include two situations: conditional handover (CHO) and conditional primary secondary cell (PSCell) change.

It was found by the inventors that an IAB-node takes a relatively long time in intra-IAB-donor-CU or inter-IAB-donor-CU migration. If a radio link of an IAB-MT deteriorates rapidly, the migration may possibly fail. In this case, according to an existing mechanism, a terminal equipment performs radio link failure (RLF) recovery through RRC reestablishment, which will cause long-term service interruption, and experiences of users served by the IAB-node and its descendant IAB-nodes will be lowered.

In order to solve one or more of the above problems, embodiments of this disclosure provide a method and apparatus for conditional reconfiguration, wherein when an IAB-node performs migration, a conditional reconfiguration mechanism is appropriately introduced, which may reduce the time of service interruption and improve user experiences.

According to a first aspect of the embodiments of this disclosure, there is provided an apparatus for conditional reconfiguration, applicable to at least one of a first IAB-node, a child IAB-node of the first IAB-node and a terminal equipment served by the first IAB-node or the child IAB-node, the apparatus including: a first selecting unit configured to select one of first cell(s) fulfilling conditional reconfiguration condition(s) from conditional reconfiguration candidate cells as a second cell; and a first executing unit configured to initiate conditional reconfiguration execution on the second cell.

According to a second aspect of the embodiments of this disclosure, there is provided an apparatus for conditional reconfiguration, applicable to a second IAB-node, the second IAB-node being a source parent IAB-node of a first IAB-node, the apparatus including: a first receiving unit configured to receive a measurement report or a control protocol data unit (PDU) for flow control feedback; and a first determining unit configured to determine a conditional reconfiguration strategy according to the measurement report or the control protocol data unit.

According to a third aspect of the embodiments of this disclosure, there is provided an apparatus for conditional reconfiguration, applicable to a second IAB-node, the second IAB-node being a source parent IAB-node of the first IAB-node, and the apparatus including: a second receiving unit configured to receive a measurement report or a control protocol data unit for flow control feedback; and a second transmitting unit configured to transmit the measurement report or the control protocol data unit to a source IAB-donor-node of the first IAB-node.

According to a fourth aspect of the embodiments of this disclosure, there is provided an apparatus for conditional reconfiguration, applicable to a source IAB-donor-node of a first IAB-node, the apparatus including: a third receiving unit configured to receive a measurement report or a control protocol data unit for flow control feedback or a downlink data transmission state protocol data unit or a notification of a radio link failure; and a second determining unit configured to determine a conditional reconfiguration strategy according to the measurement report or the control protocol data unit for flow control feedback or the downlink data transmission state protocol data unit or the notification of a radio link failure.

According to a fifth aspect of the embodiments of this disclosure, there is provided a terminal equipment, including the apparatus as described in the embodiment of the first aspect of this disclosure.

According to a sixth aspect of the embodiments of this disclosure, there is provided a network device, the network device being a first IAB-node or a child IAB-node of the first IAB-node and including the apparatus as described in the embodiment of the first aspect of this disclosure.

According to a seventh aspect of the embodiments of this disclosure, there is provided a network device, the network device being a second IAB-node, the second IAB-node being a source parent IAB-node of a first IAB-node and including the apparatus as described in the embodiment of the second aspect of this disclosure.

According to an eighth aspect of the embodiments of this disclosure, there is provided a network device, the network device being a second IAB-node, the second IAB-node being a source parent IAB-node of a first IAB-node and including the apparatus as described in the embodiment of the third aspect of this disclosure.

According to a ninth aspect of the embodiments of this disclosure, there is provided a network device, the network device being a source IAB-donor-node of a first IAB-node and including the apparatus as described in the embodiment of the fourth aspect of this disclosure.

According to a tenth aspect of the embodiments of this disclosure, there is provided a communication system, including at least one of the terminal equipment as described in the embodiment of the fifth aspect, the network device as described in the embodiment of the sixth aspect, the network device as described in the embodiment of the eighth aspect and the network device as described in the embodiment of the ninth aspect.

According to an eleventh aspect of the embodiments of this disclosure, there is provided a method for conditional reconfiguration, applicable to at least one of a first IAB-node, a child IAB-node of the first IAB-node and a terminal equipment served by the first IAB-node or the child IAB-node, the method including: selecting a first cell fulfilling a conditional reconfiguration condition from conditional reconfiguration candidate cells and taking the first cell as a second cell; and initiating conditional reconfiguration execution on the second cell.

According to a twelfth aspect of the embodiments of this disclosure, there is provided a method for conditional reconfiguration, applicable to a second IAB-node, the second IAB-node being a source parent IAB-node of a first IAB-node, the method including: receiving a measurement report or a control protocol data unit (PDU) for flow control feedback; and determining a conditional reconfiguration strategy according to the measurement report or the control protocol data unit.

According to a thirteenth aspect of the embodiments of this disclosure, there is provided a method for conditional reconfiguration, applicable to a second IAB-node, the second IAB-node being a source parent IAB-node of the first IAB-node, and the method including: receiving a measurement report or a control protocol data unit for flow control feedback; and transmitting the measurement report or the control protocol data unit to a source IAB-donor-node of the first IAB-node.

According to a fourteenth aspect of the embodiments of this disclosure, there is provided a method for conditional reconfiguration, applicable to a source IAB-donor-node of a first IAB-node, the method including: receiving a measurement report or a control protocol data unit for flow control feedback or a downlink data transmission state protocol data unit or a notification of a radio link failure; and determining a conditional reconfiguration strategy according to the measurement report or the control protocol data unit for flow control feedback or the downlink data transmission state protocol data unit or the notification of a radio link failure.

According to a fifteenth aspect of the embodiments of this disclosure, there is provided a computer readable program code, which, when executed in an apparatus for conditional reconfiguration or a terminal equipment, will cause the apparatus for conditional reconfiguration or the terminal equipment to carry out the method for conditional reconfiguration as described in the eleventh aspect of the embodiments of this disclosure.

According to a sixteenth aspect of the embodiments of this disclosure, there is provided a computer readable medium, including a computer readable program code, which will cause an apparatus for conditional reconfiguration or a terminal equipment to carry out the method for conditional reconfiguration as described in any one of the eleventh to fourteenth aspects of the embodiments of this disclosure.

An advantage of the embodiments of this disclosure exists in that when an IAB-node performs migration, a conditional reconfiguration mechanism is appropriately introduced, which may reduce the time of service interruption and improve user experiences.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of an overall architecture of IAB of an embodiment of this disclosure;

FIG. 2 is another schematic diagram of the overall architecture of the IAB of the embodiment of this disclosure;

FIG. 3 is a schematic diagram of a protocol stack of an F1-U interface between an IAB-DU and an IAB-donor-CU;

FIG. 4 is a schematic diagram of a protocol stack of an F1-C interface between an IAB-DU and an IAB-donor-CU;

FIG. 5 is a schematic diagram of a protocol stack of an SRB between an IAB-MT and an IAB-donor-CU of the embodiment of this disclosure;

FIG. 6 is a schematic diagram of a scenario of intra-IAB-donor-CU migration or topology adaptation of an IAB-node of the embodiment of this disclosure;

FIG. 7 is a schematic diagram of a scenario of inter-IAB-donor-CU migration or topology adaptation of an IAB-node of the embodiment of this disclosure;

FIG. 8 is a flowchart of a method for conditional handover in a scenario of intra-IAB-donor-CU migration;

FIG. 9 is a schematic diagram of the method for conditional reconfiguration of embodiment 1 of this disclosure;

FIG. 10 is a schematic diagram of a method for executing step 901 of embodiment 1 of this disclosure;

FIG. 11 is a schematic diagram of a method for executing step 1002 of embodiment 1 of this disclosure;

FIG. 12 is a schematic diagram of a method for executing step 1101 of embodiment 1 of this disclosure;

FIG. 13 is a schematic diagram of another method for executing step 1101 of embodiment 1 of this disclosure;

FIG. 14 is a schematic diagram of a further method for executing step 1101 of embodiment 1 of this disclosure;

FIG. 15 is a schematic diagram of still another method for executing step 1101 of embodiment 1 of this disclosure;

FIG. 16 is a schematic diagram of yet another method for executing step 1101 of embodiment 1 of this disclosure;

FIG. 17 is a schematic diagram of yet still another method for executing step 1101 of embodiment 1 of this disclosure;

FIG. 18 is a schematic diagram of further still another method for executing step 1101 of embodiment 1 of this disclosure;

FIG. 19 is a schematic diagram of yet further another method for executing step 1101 of embodiment 1 of this disclosure;

FIG. 20 is a flowchart of the method for conditional reconfiguration of embodiment 1 of this disclosure;

FIG. 21 is another flowchart of the method for conditional reconfiguration of embodiment 1 of this disclosure;

FIG. 22 is a flowchart of the method for conditional reconfiguration in a scenario of intra-IAB-donor-CU migration of embodiment 1 of this disclosure;

FIG. 23 is a flowchart of the method for conditional reconfiguration in a scenario of inter-IAB-donor-CU migration of embodiment 1 of this disclosure;

FIG. 24 is a schematic diagram of the method for conditional reconfiguration of embodiment 2 of this disclosure;

FIG. 25 is a schematic diagram of the method for conditional reconfiguration of embodiment 3 of this disclosure;

FIG. 26 is a schematic diagram of the method for conditional reconfiguration of embodiment 4 of this disclosure;

FIG. 27 is a schematic diagram of the method for conditional reconfiguration of embodiment 5 of this disclosure;

FIG. 28 is a schematic diagram of the method for conditional reconfiguration of embodiment 6 of this disclosure;

FIG. 29 is a schematic diagram of the apparatus for conditional reconfiguration of embodiment 7 of this disclosure;

FIG. 30 is a schematic diagram of the first selecting unit of embodiment 7 of this disclosure;

FIG. 31 is a schematic diagram of the second determining unit of embodiment 7 of this disclosure;

FIG. 32 is a schematic diagram of the second selecting unit of embodiment 7 of this disclosure;

FIG. 33 is another schematic diagram of the second selecting unit of embodiment 7 of this disclosure;

FIG. 34 is a further schematic diagram of the second selecting unit of embodiment 7 of this disclosure;

FIG. 35 is still another schematic diagram of the second selecting unit of embodiment 7 of this disclosure;

FIG. 36 is yet another schematic diagram of the second selecting unit of embodiment 7 of this disclosure;

FIG. 37 is a schematic diagram of the apparatus for conditional reconfiguration of embodiment 8 of this disclosure;

FIG. 38 is a schematic diagram of the apparatus for conditional reconfiguration of embodiment 9 of this disclosure;

FIG. 39 is a schematic diagram of the apparatus for conditional reconfiguration of embodiment 10 of this disclosure;

FIG. 40 is a block diagram of a systematic structure of the terminal equipment of embodiment 11 of this disclosure;

FIG. 41 is a block diagram of a systematic structure of the network device of embodiment 12 of this disclosure;

FIG. 42 is a schematic diagram of the communication system of embodiment 13 of this disclosure;

FIG. 43 is another schematic diagram of the communication system of embodiment 13 of this disclosure;

FIG. 44 is a further schematic diagram of the communication system of embodiment 13 of this disclosure; and

FIG. 45 is still another schematic diagram of the communication system of embodiment 13 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network fulfilling any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”, such as a terminal equipment in an IAB architecture served by an IAB-node or an IAB-donor.

The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, all of “when . . . ”, “in a case where . . . ”, “for a case where . . . ” and “if . . . ” denote one or some conditions or states, and furthermore, all of these expressions are interchangeable.

Scenarios of the embodiments of this disclosure shall be described below by way of examples; however, this disclosure is not limited thereto.

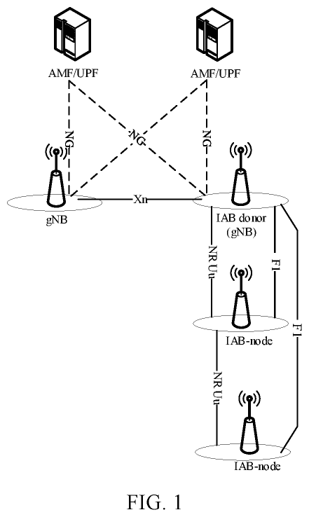

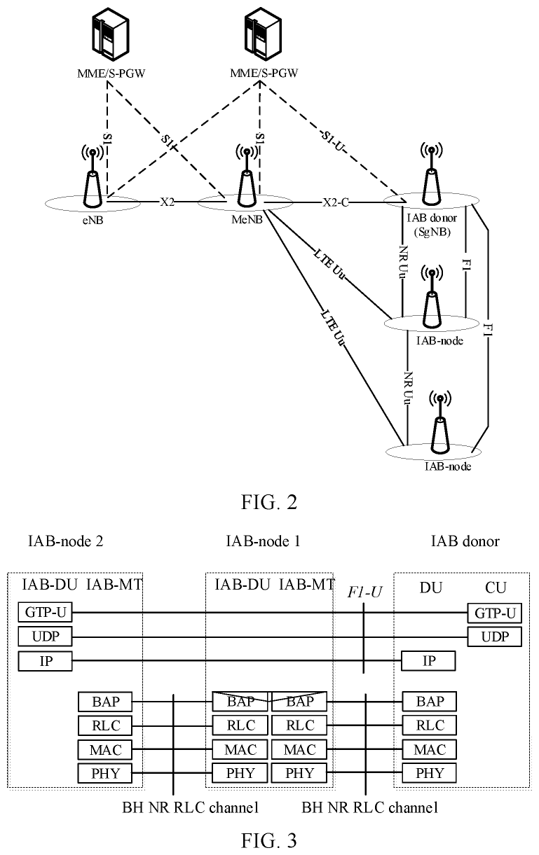

FIG. 1 is a schematic diagram of an overall architecture of an IAB in an embodiment of this disclosure. As shown in FIG. 1, the overall architecture of the IAB is in a standalone (SA) mode. FIG. 2 is another schematic diagram of the overall architecture of the IAB of the embodiment of this disclosure. As shown in FIG. 2, the overall architecture of the IAB is in a dual-connectivity (EN-DC) mode. In the dual-connectivity mode, the IAB-node is connected to an MeNB via E-UTRA, and an IAB-donor terminates X2-C as an SgNB.

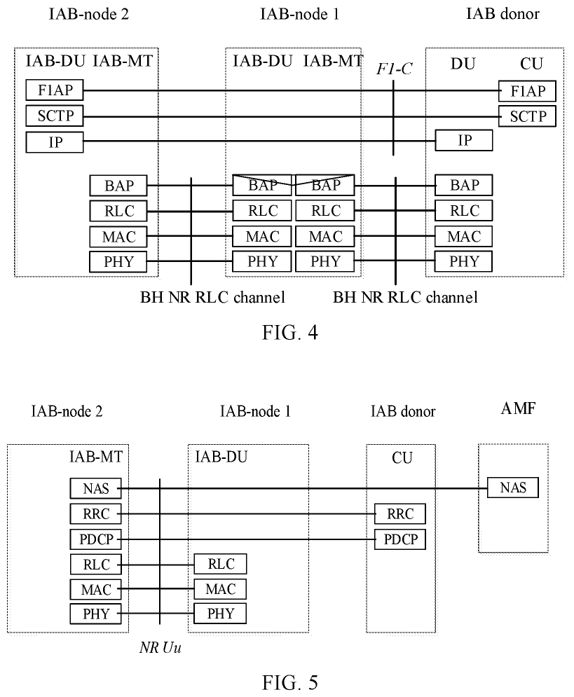

FIG. 3 is a schematic diagram of a protocol stack of an F1-U interface between an IAB-DU and an IAB-donor-CU, and FIG. 4 is a schematic diagram of a protocol stack of an F1-C interface between an IAB-DU and an IAB-donor-CU. In FIG. 3 and FIG. 4, F1-U and F1-C are illustrated by taking 2-hop backhaul as an example.

In the embodiment of this disclosure, F1-U and F1-C use an IP transmission layer between the IAB-DU and IAB-donor-CU. In addition, F1-U and F1-C have security protection.

In the embodiment of this disclosure, the IP layer transmits via a backhaul adaptation protocol (BAP) sublayer on wireless backhaul to ensure multi-hop routing; and the IP layer may also be used for non-F1 services, such as operation administration and maintenance (OAM) services.

In the embodiment of this disclosure, BAP PDUs are transmitted via BH RLC channels on each backhaul link, and on each BH link, multiple BH RLC channels may be configured to allow traffic prioritization and QoS (quality of service) enforcement.

In the embodiment of this disclosure, each IAB-node and a BAP entity on the IAB-donor-DU perform mapping of the BH RLC channels of the BAP PDUs.

In the embodiment of this disclosure, the IAB-MT and IAB-donor-CU establish SRBs for carrying RRC and NAS. FIG. 5 is a schematic diagram of a protocol stack of the SRBs between the IAB-MT and the IAB-donor-CU of the embodiment of this disclosure.

In the embodiment of this disclosure, for the IAB-node operating in the EN-DC mode, the IAB-MT also establishes one or more DRBs with the IAB-donor-CU, which may be used to transmit OAM services, for example. For the SA mode, establishment of DRBs is optional. These SRBs and DRBs are transmitted between the IAB-MT and its parent node via a Uu interface channel.

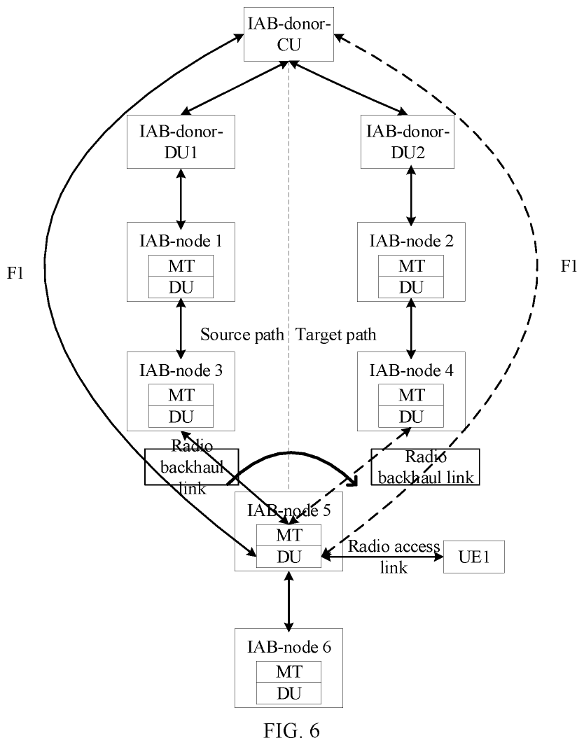

FIG. 6 is a schematic diagram of a scenario of intra-IAB-donor-CU migration or topology adaptation of an IAB-node of the embodiment of this disclosure. As shown in FIG. 6, IAB-node 5 is a migration IAB-node, IAB-node 3 is a source parent IAB-node of IAB-node 5, IAB-node 4 is a target parent IAB-node of IAB-node 5, and IAB-node 3 and IAB-node 4 are connected to identical IAB-donor-CUs and different IAB-donor-DUs. UE1 is a terminal equipment served by IAB-node, and IAB-node 6 is a descendant IAB-node served by IAB-node 5.

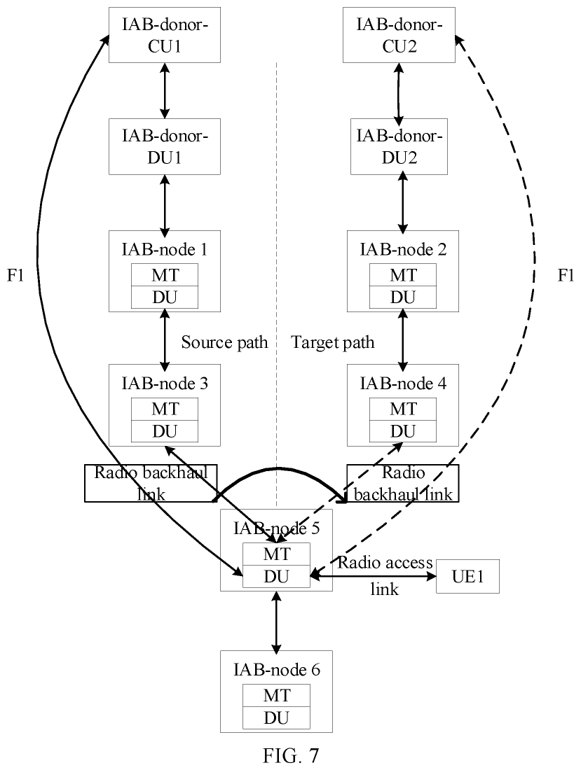

FIG. 7 is a schematic diagram of a scenario of inter-IAB-donor-CU migration or topology adaptation of an IAB-node of the embodiment of this disclosure. As shown in FIG. 7, IAB-node 5 is a migrating node, IAB-node 3 is a source parent IAB-node of IAB-node 5, IAB-node 4 is a target parent IAB-node of IAB-node 5, and IAB-node 3 and IAB-node 4 are connected to different IAB-donor-CUs and different IAB-donor-DUs. UE1 is a terminal equipment served by IAB-node 5, and IAB-node 6 is a descendant IAB-node served by IAB-node 5.

For example, IAB-node 5 in FIG. 6 and FIG. 7 takes a relatively long time in performing intra-IAB-donor-CU or inter-IAB-donor-CU migration. If a radio link of the IAB-MT deteriorates rapidly, the migration may possibly fail. In this case, according to an existing mechanism, UE1 performs radio link failure (RLF) recovery through RRC reestablishment, which will cause long-term service interruption, and experiences of users served by IAB-node 5 and its descendant IAB-node, i.e. IAB-node 6, will be lowered.

The network may configure some conditional reconfiguration candidate cells and a conditional reconfiguration condition for the terminal equipment and/or the IAB-MT of the IAB-node. The terminal equipment and/or the IAB-MT perform(s) evaluation according to the conditional reconfiguration condition, and apply/applies corresponding configuration when the evaluation conditions are fulfilled.

Specific explanations shall be given below by taking an IAB-MT as an example.

Specifically, in conditional reconfiguration, a network, such as an IAB-donor, or an IAB-donor-CU, or a source IAB-donor, or a source IAB-donor-CU, configures one or more candidate target special cells, i.e. conditional reconfiguration candidate cells, for the IAB-node. The IAB-MT evaluates conditions of each configured candidate target special cell. The IAB-MT applies conditional reconfiguration of a target special cell in target special cells fulfilling associated execution conditions. The network provides configuration parameters of the target special cell in a ConditionalReconfiguration IE.

Based on a received ConditionalReconfiguration IE, the IAB-MT performs the following actions:
if ConditionalReconfiguration includes condReconfigToRemoveList, executing a conditional reconfiguration removal procedure; and
if ConditionalReconfiguration includes condReconfigToAddModList, executing conditional reconfiguration addition and/or modification.

In the embodiment of this disclosure, the conditional reconfiguration addition and/or modification include(s) that,
for each condReconfigId received in condReconfigToAddModList, the IAB-MT will,
if an entry matching condReconfigId exists in condReconfigToAddModList in VarConditionalReconfig,
if the entry in condReconfigToAddModList includes a condExecutionCond, replace this entry with a value of the received condReconfigId;
if the entry in condReconfigToAddModList includes a condRRCReconfig, replace this entry with a value of the received condReconfigId;
otherwise, add a new entry for condReconfigId in VarConditionalReconfig;
executing conditional reconfiguration evaluation.

In the embodiment of this disclosure, the conditional reconfiguration evaluation includes that,
the IAB-MT will,
for each condReconfigId in VarConditionalReconfig,
consider that cells with physical cell identities (PCI) matching values indicated by ServingCellConfigCommon in reconfigurationWithSync in the received condRRCReconfig are applicable cells,
for each measld in measldList in VarMeasConfig indicated in condExecutionCond associated with condReconfigId,
if all measurements during corresponding time ToTrigger filtered by layer-3 defined in an applicable cell by an entry condition for an event with which condReconfigId is associated in VarConditionalReconfig, i.e. an event corresponding to condEventld(s) of corresponding condTriggerConfig in VarConditionalReconfig, are fulfilled, consider that an event with which measId is associated is fulfilled;
if all measurements during corresponding time ToTrigger filtered by layer-3 defined in an applicable cell by a departure condition for an event with which condReconfigId is associated in VarConditionalReconfig, i.e. an event corresponding to condEventld(s) of corresponding condTriggerConfig in VarConditionalReconfig, are fulfilled, consider that an event with which measId is associated is not fulfilled;
if for a target candidate cell in the stored condRRCReconfig, events with which all measld(s) in condTriggerConfig are associated are fulfilled:
consider that the target candidate cell in the stored condRRCReconfig with which condReconfigId is associated is a triggered cell;
initiate conditional reconfiguration execution.

The conditional reconfiguration execution includes that:
the terminal equipment will:
if there exists a triggered cell, select a triggered cell as a selected cell for conditional reconfiguration execution;
and for the selected cell for conditional reconfiguration execution, apply stored condRRCReconfig of the selected cell.

In the embodiment of this disclosure, the conditional reconfiguration may include two situations: conditional handover (CHO) and conditional primary secondary cell (PSCell) change.

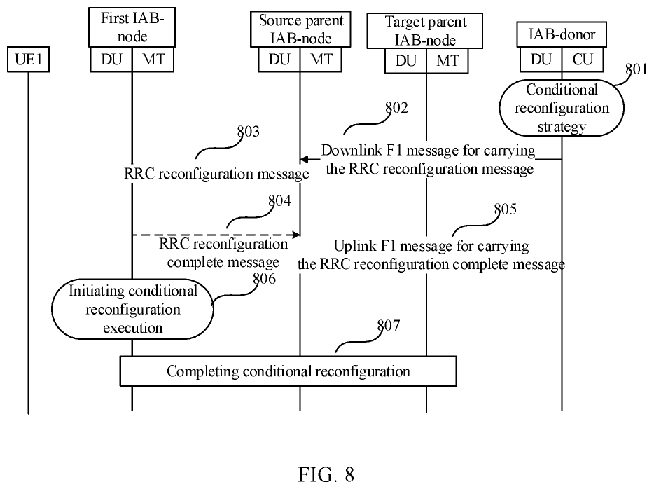

FIG. 8 is a flowchart of a method for conditional handover in a scenario of intra-IAB-donor-CU migration. As shown in FIG. 8, the method includes:
step 801: determining a conditional reconfiguration strategy by a source IAB-donor-node;
step 802: transmitting a downlink F1 message by the source IAB-donor-node to a source parent IAB-node, the downlink F1 message being used to carry an RRC reconfiguration message;
step 803: transmitting the RRC reconfiguration message by the source parent IAB-node to a first IAB-node, the RRC reconfiguration message including information on conditional reconfiguration;
step 804: transmitting an RRC reconfiguration complete message by the first IAB-node to the source parent IAB-node;
step 805: transmitting an uplink F1 message by the source parent IAB-node to the source IAB-donor-node, the uplink F1 message being used to carry the RRC reconfiguration complete message;
step 806: initiating conditional reconfiguration execution by the first IAB-node; and
step 807: completing conditional reconfiguration.

That is, in the case where the IAB-node performs migration, a conditional reconfiguration mechanism is appropriately introduced. Specific contents of conditional reconfiguration shall be described in detail in the following embodiments.

Various implementations of the embodiments of this disclosure shall be described below with reference to the accompanying drawings. These implementations are illustrative only, and are not intended to limit this disclosure.

### Embodiment 1

The embodiment of this disclosure provides a method for conditional reconfiguration, applicable to at least one of a first IAB-node, a child IAB-node of the first IAB-node and a terminal equipment served by the first IAB-node or the child IAB-node.

FIG. 9 is a schematic diagram of the method for conditional reconfiguration of embodiment 1 of this disclosure. As shown in FIG. 9, the method includes:
step 901: selecting a first cell fulfilling a conditional reconfiguration condition from conditional reconfiguration candidate cells and taking the first cell as a second cell; and
step 902: initiating conditional reconfiguration execution on the second cell.

In the embodiment of this disclosure, the first IAB-node is a migration IAB-node.

In the embodiment of this disclosure, the parent IAB-node refers to a parent IAB-node of the first IAB-node, and the child IAB-node refers to a child IAB-node of the first IAB-node.

Hence, when the IAB-node performs migration, a conditional reconfiguration mechanism is appropriately introduced, which may reduce the time of service interruption and improve user experiences.

In the embodiment of this disclosure, the conditional reconfiguration may include conditional handover (CHO) and/or conditional PSCell change.

In the embodiment of this disclosure, the conditional reconfiguration candidate cell may be referred to as an applicable cell, or may also be referred to as a target candidate cell.

In the embodiment of this disclosure, the conditional reconfiguration candidate cell may include a conditional handover (CHO) candidate cell and/or a conditional PSCell change candidate cell.

For example, the conditional reconfiguration candidate cell includes a conditional handover candidate cell, i.e. a cell with its reconfigurationWithSync being included in masterCellGroup of a variable VarConditionalReconfig, and/or a conditional PSCell change cell, i.e. a cell with its reconfigurationWithSync being included in secondaryCellGroup of the variable VarConditionalReconfig.

In the embodiment of this disclosure, the first cell is also referred to as a triggering cell, and the second cell is also referred to as a selected cell.

In the embodiment of this disclosure, the conditional reconfiguration execution may include applying corresponding stored configuration, which may be corresponding configuration of a stored conditional handover (CHO) candidate cell or a conditional PSCell change candidate cell.

In the embodiment of this disclosure, the conditional reconfiguration condition may also be referred to as a condition for executing conditional reconfiguration.

In the embodiment of this disclosure, the conditional reconfiguration condition may include at least one of the following conditions that:
1) a radio link failure of a link with its parent IAB-node is detected;
2) a notification of a radio link failure from the parent IAB-node is received;
3) a first indication triggering conditional reconfiguration from the parent IAB-node is received;
4) a second indication of flow control from the parent IAB-node is received;
5) quality of a conditional reconfiguration candidate cell becomes better than a PCell and/or a PSCell or quality of a conditional reconfiguration candidate cell becomes offset better than a PCell and/or a PSCell;
6) quality of a PCell and/or a PSCell becomes worse than a first threshold and quality of a conditional reconfiguration candidate cell becomes better than a second threshold; and
7) quality of a conditional reconfiguration candidate cell becomes better than a third threshold or quality of a conditional reconfiguration candidate cell becomes offset better than a third threshold.

In the embodiment of this disclosure, a first group of conditions may include conditions 1)-4), and a second group of conditions may include conditions 5)-7).

When a condition in the first group of conditions is fulfilled, the conditional reconfiguration candidate cell/conditional handover candidate cell/conditional PSCell change candidate cell is/are considered as the first cell, that is, as long as a cell is a conditional reconfiguration cell/conditional handover candidate cell/conditional PSCell change candidate cell, the cell is the first cell; or, when an MCG fulfills a condition in the first group of conditions, the conditional handover candidate cell is considered the first cell, that is, as long as a cell is a conditional handover candidate cell, the cell is the first cell; or, when an SCG fulfills a condition in the first group of conditions, the conditional PSCell change candidate cell is considered as the first cell, that is, as long as a cell is a conditional PSCell change candidate cell, the cell is the first cell.

That an MCG fulfills a condition in the first group of conditions includes detecting a failure of an MCG radio link with its parent IAB-node, or receiving a radio link failure notification of its parent IAB-node from the MCG, or receiving a first indication triggering conditional reconfiguration of the parent IAB-node from the MCG, or receiving a second indication of flow control of the parent IAB-node from the MCG.

That the SCG fulfills a condition in the first group of conditions includes detecting a failure of an SCG radio link with its parent IAB-node, or receiving a radio link failure notification of the parent IAB-node from the SCG, or receiving the first indication triggering conditional reconfiguration of the parent IAB-node from the SCG, or receiving a second indication of flow control of the parent IAB-node from the MCG.

In above condition 2) and/or condition 3), for example, the BAP may control the PDU to receive the radio link failure notification and/or the first indication, or receive the radio link failure notification and/or the first indication via a system message, or receive the radio link failure notification and/or the first indication via a paging message.

In the embodiment of this disclosure, when the radio link failure notification and/or the first indication is/are received via a paging message, at least one of the radio link failure notification and the first indication may be included in a short message of the paging message and indicated via downlink control information (DCI).

Or, when the radio link failure notification and/or the first indication is/are received via the system message, an update indication of the system message may be included in a short message of the paging message and indicated via downlink control information (DCI).

In above condition 3), the radio link failure notification may include at least one of a type-4 radio link failure notification, a type-2 radio link failure notification, and a type-3 radio link failure notification.

For example, a meaning of the type-4 radio link failure notification is that an RRC reestablishment procedure of the parent IAB-node fails, a meaning of the type-2 radio link failure notification is that the parent IAB-node detects a radio link failure, and a meaning of the type-3 radio link failure notification is that the parent IAB-node cancels or recovers a radio link failure.

In above condition 4), for example, the receiving a second indication of flow control from the parent IAB-node includes receiving a second indication based on an available buffer size or based on a buffer overload.

For example, the second indication includes information indicating the available buffer size and/or information indicating buffer overload of its parent IAB-node.

For the second indication based on the available buffer size, for example, the second indication based on the available buffer size may reuse an existing control protocol data unit (PDU) for flow control feedback.

Indication contents of the second indication may include an available buffer size, i.e. a maximum amount of traffics that the parent IAB-node should transmit, including a per BAP routing ID available buffer size or a per BH RLC channel available buffer size.

For example, the receiving a second indication based on an available buffer size includes receiving the second indication based on the available buffer size and information on the available buffer size indicates that the available buffer size is greater than a fourth threshold, that is, the execution condition is that the available buffer size is greater than the fourth threshold, and conditional reconfiguration is executed.

For the second indication based on the buffer overload,
indication contents of the second indication may include a parent IAB-node buffer overload; for example, on the parent IAB-node, buffer sizes with which N BAP routing IDs or M% of BAP routing IDs or BH BLC channels are associated are greater than a fifth threshold.

For example, the execution condition is executing condition reconfiguration once the second indication is received.

In above condition 6), it may be that quality of a PCell and/or a PSCell becomes worse than a first threshold, and quality of a conditional reconfiguration candidate cell becomes better than a second threshold,
or, it may be that quality of a PCell and/or a PSCell becomes offset worse than a first threshold, and quality of a conditional reconfiguration candidate cell becomes better than the second threshold;
or, it may be that quality of a PCell and/or a PSCell becomes worse than a first threshold, and quality of a conditional reconfiguration candidate cell becomes offset better than the second threshold;
or, it may be that quality of a PCell and/or a PSCell becomes offset worse than a first threshold, and quality of a conditional reconfiguration candidate cell becomes offset better than the second threshold.

In step 901, a first cell fulfilling the conditional reconfiguration condition is selected from the conditional reconfiguration candidate cells and is taken as the second cell. There may be one or at least two first cells that satisfy the conditional reconfiguration condition, which may be processed separately.

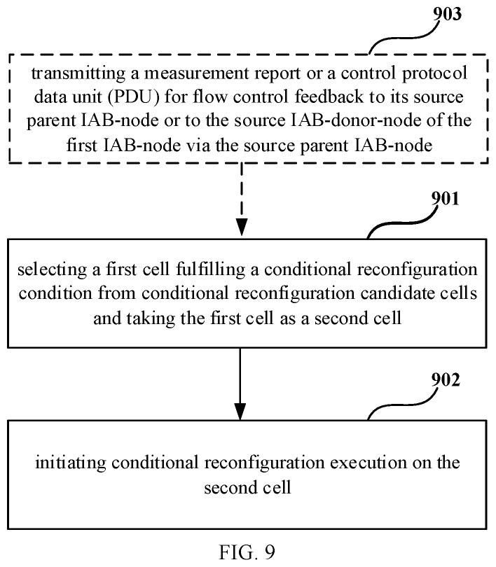

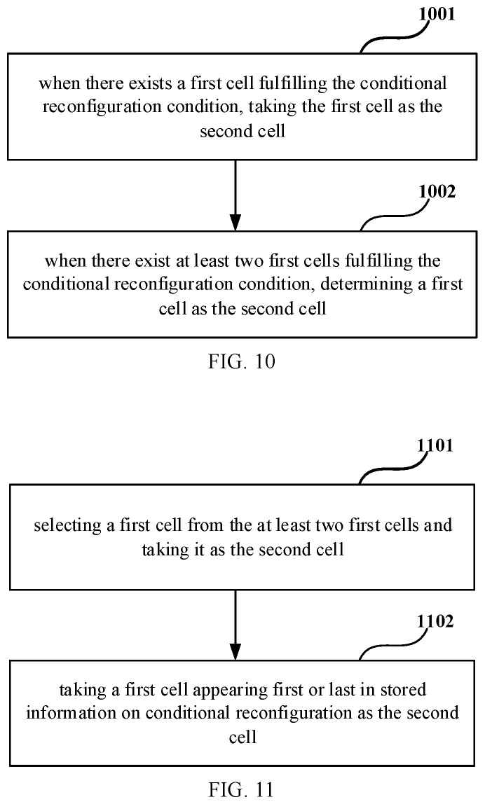

FIG. 10 is a schematic diagram of a method for executing step 901 of embodiment 1 of this disclosure. As shown in FIG. 10, the method includes:
step 1001: when there exists a first cell fulfilling the conditional reconfiguration condition, taking the first cell as the second cell; and
step 1002: when there exist at least two first cells fulfilling the conditional reconfiguration condition, determining a first cell as the second cell.

In step 1001, when there is only one first cell in the candidate cells that fulfills the conditional reconfiguration condition, the first cell is directly taken as the second cell, i.e. a cell initiating conditional reconfiguration execution.

In step 1002, when there are at least two first cells in the conditional reconfiguration candidate cells that satisfy the conditional reconfiguration condition, one of the first cells is determined as the second cell.

A method for determining a first cell as the second cell in step 1002 shall be described below.

FIG. 11 is a schematic diagram of a method for executing step 1002 of embodiment 1 of this disclosure. As shown in FIG. 11, the method includes:
step 1101: selecting a first cell from the at least two first cells and taking it as the second cell; and/or
step 1102: taking a first cell appearing first or last in stored information on conditional reconfiguration as the second cell.

In the embodiment of this disclosure, at least one of steps 1101 and 1102 may be executed. In addition, an order of execution of steps 1101 and 1102 is not limited in the embodiment of this disclosure. For example, steps 1101 and 1102 may be executed in parallel, or may be executed sequentially.

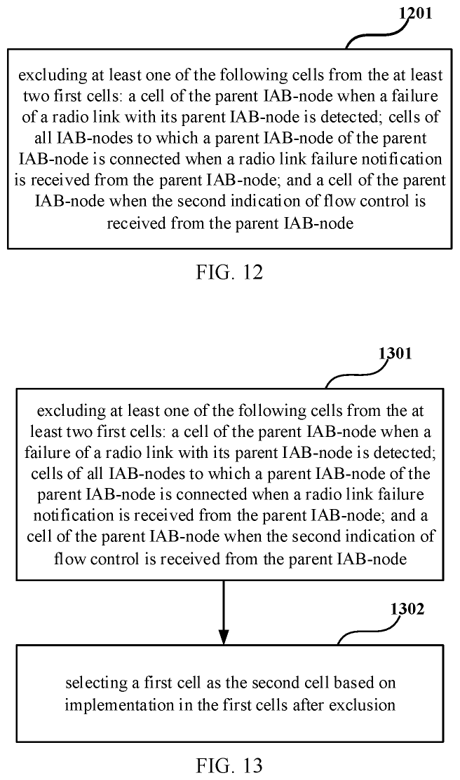

FIG. 12 is a schematic diagram of a method for executing step 1101 of embodiment 1 of this disclosure. As shown in FIG. 12, the method includes:
step 1201: excluding at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node.

In the embodiment of this disclosure, the radio link failure notification may include a type-4 radio link failure notification and/or a type-2 radio link failure notification.

In the embodiment of this disclosure, for example, step 1102 in FIG. 11 may be executed after step 1201 is executed, that is, after exclusion is performed in at the least two first cells, the second cell may be determined according to an order of appearances.

FIG. 13 is a schematic diagram of another method for executing step 1101 of embodiment 1 of this disclosure. As shown in FIG. 13, the method includes:
step 1301: excluding at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node; and
step 1302: selecting a first cell as the second cell based on implementation in the first cells after exclusion.

Step 1301 is identical to step 1201, and in the method shown in FIG. 13, based on step 1301, a first cell is selected as the second cell based on implementation in step 1302, that is, in the first cells after exclusion, such as by taking a beam situation in the remaining first cells and/or a capability of the IAB-MT into account.

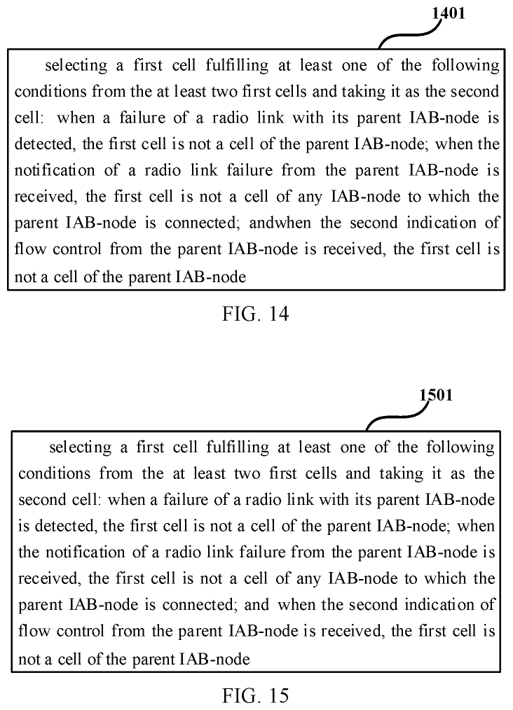

FIG. 14 is a schematic diagram of a further method for executing step 1101 of embodiment 1 of this disclosure. As shown in FIG. 14, the method includes:
step 1401: selecting a first cell fulfilling at least one of the following conditions from the at least two first cells and taking it as the second cell:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

In the embodiment of this disclosure, the radio link failure notification may include a type-4 radio link failure notification and/or a type-2 radio link failure notification.

In the embodiment of this disclosure, for example, step 1102 in FIG. 11 may be executed after more than one first cells fulfilling at least one of the above conditions are selected from the least two first cells in step 1401, that is, the second cell is determined according to an order of appearances after selection is performed in the least two first cells.

FIG. 15 is a schematic diagram of still another method for executing step 1101 of embodiment 1 of this disclosure. As shown in FIG. 15, the method includes:
step 1501: selecting a first cell fulfilling at least one of the following conditions from the at least two first cells and taking it as the second cell:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

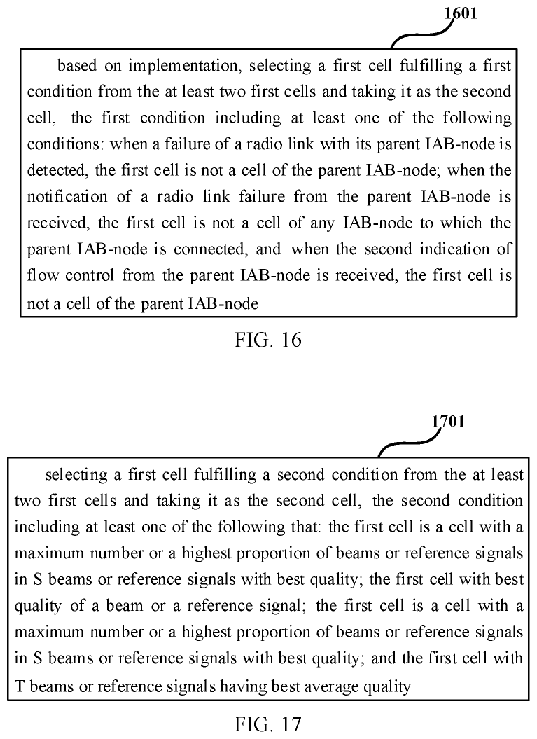

FIG. 16 is a schematic diagram of yet another method for executing step 1101 of embodiment 1 of this disclosure. As shown in FIG. 16, the method includes:
step 1601: based on implementation, selecting a first cell fulfilling a first condition from the at least two first cells and taking it as the second cell,
the first condition including at least one of the following conditions:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

In comparison with step 1501, on the basis of fulfilling the first condition, a first cell is further selected based on implementation in step 1601.

FIG. 17 is a schematic diagram of yet still another method for executing step 1101 of embodiment 1 of this disclosure. As shown in FIG. 17, the method includes:
step 1701: selecting a first cell fulfilling a second condition from the at least two first cells and taking it as the second cell,
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
the first cell with T beams or reference signals having best average quality.

In the embodiment of this disclosure, the quality may include RSRP of L1 layer, RSRQ of L1 layer, an SINR value of L1 layer, and at least one of RSRP, RSRQ and SINR value filtered by layer 3.

In the embodiment of this disclosure, the reference signal is, for example, an SSB and/or a CSR-RS.

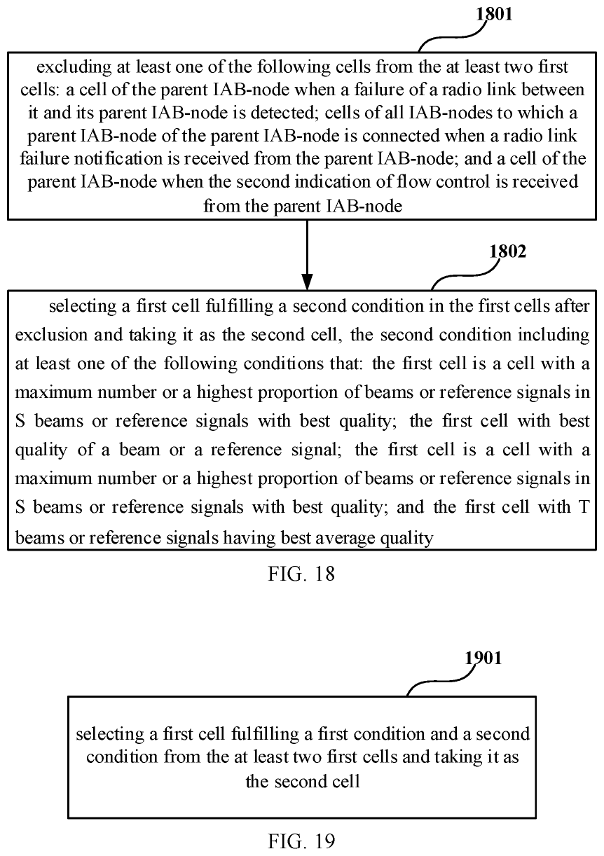

FIG. 18 is a schematic diagram of further still another method for executing step 1101 of embodiment 1 of this disclosure. As shown in FIG. 18, the method includes:
step 1801: excluding at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node; and
step 1802: selecting a first cell fulfilling a second condition in the first cells after exclusion and taking it as the second cell,
the second condition including at least one of the following conditions that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
the first cell with T beams or reference signals having best average quality.

Step 1801 is identical to step 1201 and step 1301, and specific contents of the second condition in step 1802 are identical to those of the above second condition.

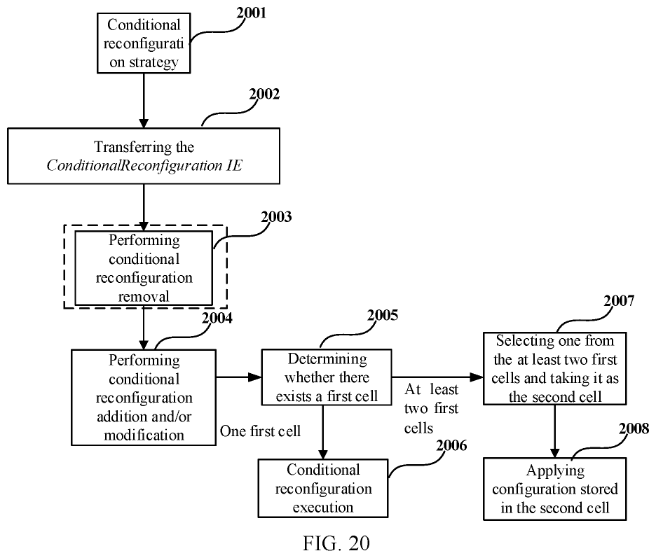

FIG. 19 is a schematic diagram of yet further another method for executing step 1101 of embodiment 1 of this disclosure. As shown in FIG. 19, the method includes:
step 1901: selecting a first cell fulfilling a first condition and a second condition from the at least two first cells and taking it as the second cell,
the first condition including at least one of the following that:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node;
and the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
the first cell with T beams or reference signals having best average quality.

In step 1901, specific contents of the first condition and the second condition are identical to those of the above first condition and second condition.

The methods for executing step 1101 are described above; however, the embodiment of this disclosure is not limited to the above methods for executing.

Or, it may also be that the second cell is determined in other means rather than selecting a first cell in multiple first cells fulfilling the conditional reconfiguration condition and taking it as the second cell.

For example, in step 1102, the first cell appearing first or last in the stored information on conditional reconfiguration is taken as the second cell.

For example, a first cell appearing first or last in condRRCReconfig is taken as the second cell.

After the second cell is determined in step 901, conditional reconfiguration execution is initiated on the second cell in step 902.

For example, in step 902, the selected configuration stored in the second cell is applied on the second cell.

In the embodiment of this disclosure, for example, the CU of the IAB-donor-node of the first IAB-node controls the IAB-MT of the first IAB-node or the IAB-MT of the child IAB-node or the terminal equipment to apply the method of conditional reconfiguration.

For example, the CU controls as per IAB-MT or as per terminal equipment, or the CU controls based on the conditional reconfiguration condition, or the CU controls based on a conditional reconfiguration candidate cell.

For the case where the CU controls as per IAB-MT or as per terminal equipment, for example, the CU configures an IAB-node or terminal equipment, and allows for executing the method of conditional reconfiguration. That is, for a target candidate cell, if the conditional reconfiguration condition is fulfilled, the IAB-MT or terminal equipment initiates conditional reconfiguration execution.

For the case where the CU controls based on the conditional reconfiguration condition, for example,
when the CU configures at least one conditional reconfiguration condition belonging to a first group of conditions for an IAB-node or terminal equipment and allows the IAB-node or terminal equipment to execute the method of conditional reconfiguration based on the at least one conditional reconfiguration condition to determine whether to initiate conditional reconfiguration execution, the method of conditional reconfiguration, i.e. the method of conditional reconfiguration in the embodiment of this disclosure, is executed.

The first group of conditions includes at least one conditional reconfiguration condition in the above conditions 1)-4), that is, at least one of the following conditions that:
a radio link failure of a link with its parent IAB-node is detected;
a notification of a radio link failure from the parent IAB-node is received;
a first indication triggering conditional reconfiguration from the parent IAB-node is received; and
a second indication of flow control from the parent IAB-node is received.

For example, when the CU configures an IAB-node or terminal equipment with receiving an RLF notification from the parent IAB-node, the execution of a method of conditional reconfiguration allowed to be executed; then, for this IAB-node or terminal equipment, only when the conditional reconfiguration including “receiving an RLF notification from the parent IAB-node” is fulfilled, the following method is executed: for a target candidate cell, initiating conditional reconfiguration execution by the IAB-MT or UE if the conditional reconfiguration condition is fulfilled.

For the case where the CU controls based on the conditional reconfiguration candidate cell, control may be performed based on the conditional reconfiguration candidate cell only, or control may be performed based on the conditional reconfiguration candidate cell and the conditional reconfiguration condition.

In the embodiment of this disclosure, the CU may control via RRC configuration and/or Fl configuration.

For example, for the case where the CU controls via RRC configuration,
when an added optional field of an ENUMERATED type in an ConditionalReconfiguration IE is present, it is determined that an IAB-node or terminal equipment executes the method of conditional reconfiguration; and/or,
when an added optional field of an ENUMERATED type in CondReconfigToAddMod-r16 of IE CondReconfigToAddModList is present, for a corresponding target candidate cell and/or a conditional reconfiguration condition, it is determined that an IAB-node or terminal equipment executes the method of conditional reconfiguration.

In the embodiment of this disclosure, as shown in FIG. 9, the method may further include:
step 903: transmitting a measurement report or a control protocol data unit (PDU) for flow control feedback to its source parent IAB-node or to the source IAB-donor-node of the first IAB-node via the source parent IAB-node.

That is, a conditional reconfiguration strategy is determined by the source parent IAB-node or the source IAB-donor-node, that is, the source parent IAB-node of the first IAB-node or the source IAB-donor-node determines whether to apply the method of conditional reconfiguration of the embodiment of this disclosure according to the received measurement report or the control protocol data unit for flow control feedback.

In the embodiment of this disclosure, the parent IAB-node determines the conditional reconfiguration strategy, which enables faster configuration of conditional reconfiguration and further reduces the time of service interruption.

In the embodiment of this disclosure, the IAB-donor determines the conditional reconfiguration strategy, which may take the entire topology situation into account, and provide information on better conditional reconfiguration for the IAB-node, thereby improving a success rate of conditional reconfiguration execution.

Flows of the method of conditional reconfiguration of the embodiment of this disclosure in different scenarios shall be illustrated below.

FIG. 20 is a flowchart of the method for conditional reconfiguration of embodiment 1 of this disclosure. As shown in FIG. 20, the method includes:
step 2001: determining a conditional reconfiguration strategy, such as determined by the source parent IAB-node or the source IAB-donor-node;
step 2002: transferring ConditionalReconfiguration IE;
step 2003: performing conditional reconfiguration removal; for example, if ConditionalReconfiguration includes condReconfigToRemoveList, a conditional reconfiguration removal procedure is performed;
step 2004: performing conditional reconfiguration addition and/or modification; for example, if ConditionalReconfiguration includes condReconfigToAddAlodList, conditional reconfiguration addition and/or modification is executed;
step 2005: performing evaluation, specifically, determining whether there exists a first cell fulfilling the conditional reconfiguration condition, i.e. a triggering cell;
step 2006: when there exists a first cell, initiating conditional reconfiguration execution on the first cell;
step 2007: when there exist at least two first cells, selecting one from the at least two first cells and taking it as the second cell; and
step 2008: applying configuration stored in the second cell.

In the method shown in FIG. 20, after receiving ConditionalReconfiguration IE, evaluation is performed directly, i.e. the first cell (triggering cell) is determined.

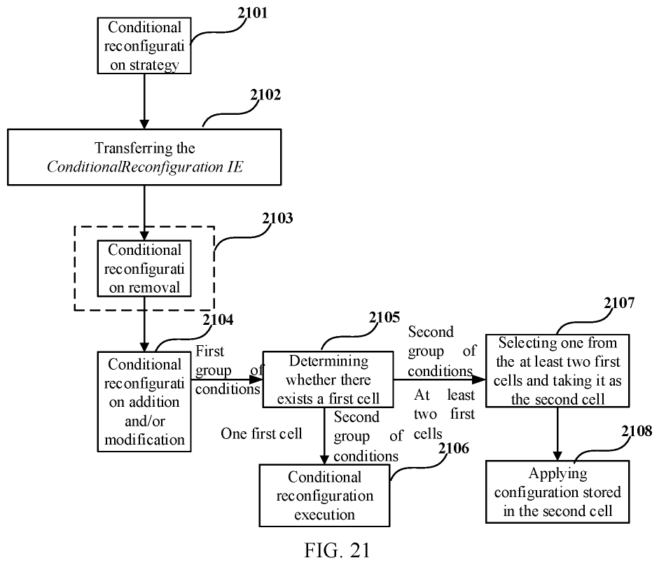

FIG. 21 is another flowchart of the method for conditional reconfiguration of embodiment 1 of this disclosure. As shown in FIG. 21, the method includes:
step 2101: determining a conditional reconfiguration strategy, such as by the source parent IAB-node or the source IAB-donor-node;
step 2102: transferring the ConditionalReconfiguration IE;
step 2103: performing conditional reconfiguration removal; for example, if ConditionalReconfiguration includes condReconfigToRemoveList, a conditional reconfiguration removal procedure is executed;
step 2104: performing conditional reconfiguration addition and/or modification; for example, if ConditionalReconfiguration includes condReconfigToAddAlodList, conditional reconfiguration addition and/or modification is executed;
step 2105: performing evaluation when at least one condition in the first group of conditions is fulfilled, specifically, when at least one condition in the first group of conditions is fulfilled, determining whether there exists a first cell fulfilling the conditional reconfiguration condition, i.e. a triggering cell;
step 2106: when there exists a first cell and at least one condition in the second group of conditions is fulfilled, initiating conditional reconfiguration execution on the first cell;
step 2107: when there exist at least two first cells and at least one condition in the second group of conditions is fulfilled, selecting one from the at least two first cells and taking it as the second cell; and
step 2108: initiating conditional reconfiguration execution on the second cell.

That is, in the method shown in FIG. 21, after receiving ConditionalReconfiguration IE, only removal, addition and/or modification of conditional reconfiguration is/are performed. When at least one condition in the first group of conditions is fulfilled, evaluation is performed, i.e. determining whether there exists a first cell (triggering cell), and when at least one condition in the second group of conditions is also fulfilled, conditional reconfiguration execution is initiated on the second cell (selected cell) determined from the first cell.

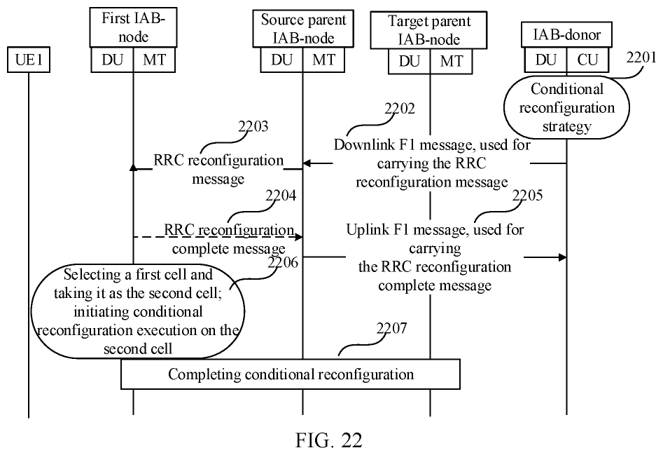

FIG. 22 is a flowchart of the method for conditional reconfiguration in a scenario of intra-IAB-donor-CU migration of embodiment 1 of this disclosure. As shown in FIG. 22, the method includes:
step 2201: determining a conditional reconfiguration strategy by the source IAB-donor-node;
step 2202: transmitting a downlink F1 message by the source IAB-donor-node to the source parent IAB-node to carry an RRC reconfiguration message;
step 2203: transmitting the RRC reconfiguration message by the source parent IAB-node to the first IAB-node, including the information on conditional reconfiguration;
step 2204: transmitting an RRC reconfiguration complete message by the first IAB-node to the source parent IAB-node;
step 2205: transmitting an uplink F1 message by the source parent IAB-node to the source IAB-donor-node, the uplink F1 message being used to carry the RRC reconfiguration complete message;
step 2206: selecting a first cell fulfilling the conditional reconfiguration condition by the first IAB-node from the conditional reconfiguration candidate cells and taking it as the second cell, and initiating conditional reconfiguration execution on the second cell; and
step 2207: completing condition reconfiguration.

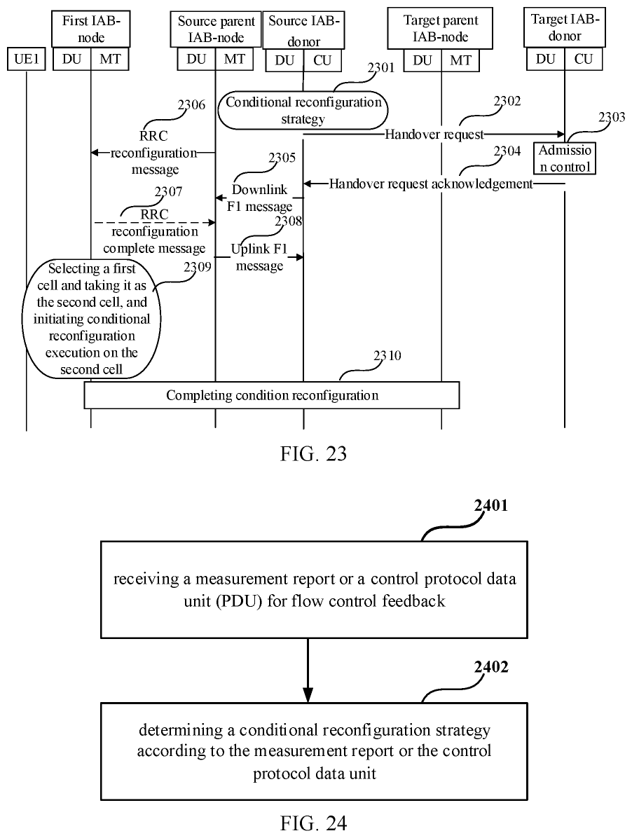

FIG. 23 is a flowchart of the method for conditional reconfiguration in a scenario of inter-IAB-donor-CU migration of embodiment 1 of this disclosure. As shown in FIG. 23, the method includes:
step 2301: determining a conditional reconfiguration strategy by the source IAB-donor-node;
step 2302: transmitting a handover request by the source IAB-donor-node to the target IAB-donor-node;
step 2303: performing admission control by the target IAB-donor-node;
step 2304: transmitting handover request acknowledgement by the target IAB-donor-node to the source IAB-donor-node;
step 2305: transmitting a downlink F1 message by the source IAB-donor-node to the source parent IAB-node, the downlink F1 message being used to carry the RRC reconfiguration message;
step 2306: transmitting the RRC reconfiguration message by the source parent IAB-node to the first IAB-node, including the information on conditional reconfiguration;
step 2307: transmitting an RRC reconfiguration complete message by the first IAB-node to the source parent IAB-node;
step 2308: transmitting an uplink F1 message by the source parent IAB-node to the source IAB-donor-node, the uplink F1 message being used to carry the RRC reconfiguration complete message;
step 2309: selecting a first cell fulfilling the conditional reconfiguration condition by the first IAB-node from the conditional reconfiguration candidate cells and taking it as the second cell, and initiating conditional reconfiguration execution on the second cell;
step 2310: completing condition reconfiguration.

Reference may be made to what is described above for specific implementations of the steps in FIG. 20 to FIG. 23, which shall not be repeated herein any further.

It can be seen from the above embodiment that when an IAB-node performs migration, a conditional reconfiguration mechanism is appropriately introduced, which may reduce the time of service interruption and improve user experiences.

### Embodiment 2

The embodiment of this disclosure provides a method for conditional reconfiguration, applicable to a second IAB-node, the second IAB-node being a source parent IAB-node of a first IAB-node. This method corresponds to embodiment 1, and reference may be made to embodiment 1 for identical contents.

In the embodiment of this disclosure, the first IAB-node is a migration IAB-node.

In embodiment 2, the second IAB-node, i.e. the source parent IAB-node of the first IAB-node, determines a conditional reconfiguration strategy.

FIG. 24 is a schematic diagram of the method for conditional reconfiguration of embodiment 2 of this disclosure. As shown in FIG. 24, the method includes:
step 2401: receiving a measurement report or a control protocol data unit (PDU) for flow control feedback; and
step 2402: determining a conditional reconfiguration strategy according to the measurement report or the control protocol data unit.

In the embodiment of this disclosure, the measurement report may be from an IAB-MT of the first IAB-node, or an IAB-MT of a child IAB-node of the first IAB-node, or a terminal equipment served by the first IAB-node or the child IAB-node.

In the embodiment of this disclosure, the control protocol data unit may be from the IAB-MT of the first IAB-node or the IAB-MT of the child IAB-node of the first IAB-node.

In this embodiment, reference may be made to the disclosure contained in embodiment 1 for specific contents concerned in steps 2401 and 2402, which shall not be repeated herein any further.

It can be seen from the above embodiment that when an IAB-node performs migration, a conditional reconfiguration mechanism is appropriately introduced, which may reduce the time of service interruption and improve user experiences. In addition, the parent IAB-node determines the conditional reconfiguration strategy, which enables faster configuration of conditional reconfiguration and further reduces the time of service interruption.

### Embodiment 3

The embodiment of this disclosure provides a method for conditional reconfiguration, applicable to a second IAB-node, the second IAB-node being a source parent IAB-node of a first IAB-node. This method corresponds to embodiment 1, and reference may be made to embodiment 1 for identical contents.

In the embodiment of this disclosure, the first IAB-node is a migration IAB-node.

In embodiment 3, a source IAB-donor-node of the first IAB-node determines a conditional reconfiguration strategy, and the second IAB-node, i.e. the source parent IAB-node of the first IAB-node, forwards related information to the source IAB-donor-node.

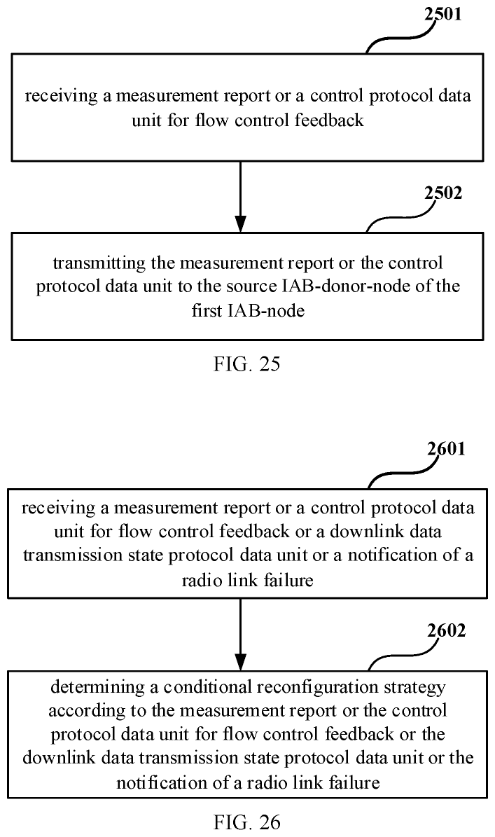

FIG. 25 is a schematic diagram of the method for conditional reconfiguration of embodiment 3 of this disclosure. As shown in FIG. 25, the method includes:
step 2501: receiving a measurement report or a control protocol data unit for flow control feedback; and
step 2502: transmitting the measurement report or the control protocol data unit to the source IAB-donor-node of the first IAB-node.

In the embodiment of this disclosure, the measurement report may be from an IAB-MT of the first IAB-node, or an IAB-MT of a child IAB-node of the first IAB-node, or a terminal equipment served by the first IAB-node or the child IAB-node.

In the embodiment of this disclosure, the control protocol data unit may be from the IAB-MT of the first IAB-node or the IAB-MT of the child IAB-node of the first IAB-node.

In the embodiment of this disclosure, the measurement report or the control protocol data unit may be received via a BH link.

In the embodiment of this disclosure, the measurement report or the control protocol data unit may be transmitted to the source IAB-donor-node of the first IAB-node via an F1 interface.

In this embodiment, reference may be made to the disclosure contained in embodiment 1 for specific contents concerned in steps 2501 and 2502, which shall not be repeated herein any further.

It can be seen from the above embodiment that when an IAB-node performs migration, a conditional reconfiguration mechanism is appropriately introduced, which may reduce the time of service interruption and improve user experiences. In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 4

The embodiment of this disclosure provides a method for conditional reconfiguration, applicable to a source IAB-donor-node of a first IAB-node. This method corresponds to embodiment 1, and reference may be made to embodiment 1 for identical contents.

In the embodiment of this disclosure, the first IAB-node is a migration IAB-node.

In embodiment 4, the source IAB-donor-node of the first IAB-node determines a conditional reconfiguration strategy.

FIG. 26 is a schematic diagram of the method for conditional reconfiguration of embodiment 4 of this disclosure. As shown in FIG. 26, the method includes:
step 2601: receiving a measurement report or a control protocol data unit for flow control feedback or a downlink data transmission state protocol data unit or a notification of a radio link failure; and
step 2602: determining a conditional reconfiguration strategy according to the measurement report or the control protocol data unit for flow control feedback or the downlink data transmission state protocol data unit or the notification of a radio link failure.

In the embodiment of this disclosure, the measurement report may be from an IAB-MT of the first IAB-node or an IAB-MT of a child IAB-node of the first IAB-node or a terminal equipment served by the first IAB-node or served by the child IAB-node of the first IAB-node

In the embodiment of this disclosure, the control protocol data unit may be from the IAB-MT of the first IAB-node or the IAB-MT of the child IAB-node of the first IAB-node.

In the embodiment of this disclosure, the downlink data transmission state protocol data unit may be from the parent IAB-node or an access IAB-node of the terminal equipment served by the first IAB-node or served by the child IAB-node of the first IAB-node.

In the embodiment of this disclosure, the notification of a radio link failure may be from the parent IAB-node or an access IAB-node of the terminal equipment served by the first IAB-node or served by the child IAB-node of the first IAB-node.

In the embodiment of this disclosure, the measurement report or the control protocol data unit or the downlink data transmission state protocol data unit or the notification of a radio link failure may be received via an F1 interface.

In this embodiment, reference may be made to the disclosure contained in embodiment 1 for specific contents concerned in steps 2601 and 2602, which shall not be repeated herein any further.

It can be seen from the above embodiment that when an IAB-node performs migration, a conditional reconfiguration mechanism is appropriately introduced, which may reduce the time of service interruption and improve user experiences. In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 5

The embodiment of this disclosure provides a method for conditional reconfiguration, applicable to at least one of a first IAB-node, a child IAB-node of the first IAB-node and a terminal equipment served by the first IAB-node or the child IAB-node as well as a source parent IAB-node of the first IAB-node, i.e. a second IAB-node.

In the embodiment of this disclosure, the first IAB-node is a migration IAB-node, and the second IAB-node is the source parent IAB-node of the first IAB-node.

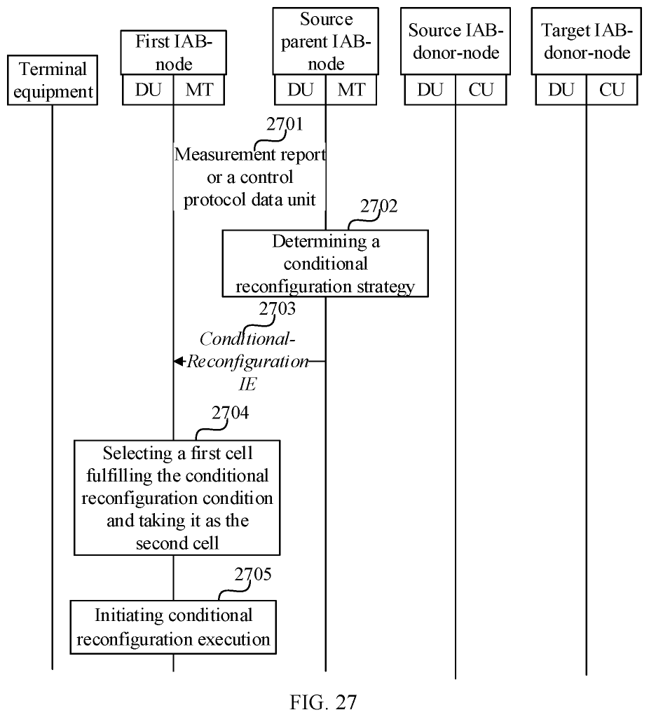

FIG. 27 is a schematic diagram of the method for conditional reconfiguration of embodiment 5 of this disclosure. As shown in FIG. 27, the method includes:
step 2701: transmitting a measurement report or a control protocol data unit for flow control feedback by the first IAB-node to the source parent IAB-node;
step 2702: determining a conditional reconfiguration strategy by the source parent IAB-node according to the measurement report or the control protocol data unit for flow control feedback;
step 2703: transmitting ConditionalReconfiguration IE by the source parent IAB-node to the first IAB-node;
step 2704: selecting a first cell fulfilling the conditional reconfiguration condition by the IAB-MT of the first IAB-node from conditional reconfiguration candidate cells and taking it as the second cell; and
step 2705: initiating conditional reconfiguration execution on the second cell by the IAB-MT of the first IAB-node.

In the embodiment of this disclosure, the measurement report transmitted by the first IAB-node to the source parent IAB-node may be from the IAB-MT of the first IAB-node, or may be from the IAB-MT of the child IAB-node of the first IAB-node, or may be the terminal equipment served by the first IAB-node or the child IAB-node.

In the embodiment of this disclosure, the control protocol data unit for flow control feedback transmitted by the first IAB-node to the source parent IAB-node may be from the IAB-MT of the first IAB-node, or may be from the IAB-MT of the child IAB-node of the first IAB-node.

In step 2701, the measurement report or the control protocol data unit may be transmitted and received via a BH link.

In the embodiment of this disclosure, reference may be made to the disclosure contained in embodiment 1 for specific contents concerned in steps 2701-2704, which shall not be repeated herein any further.

In addition, other information exchange may be performed between the IAB-node, the IAB-donor-node and the terminal equipment, and reference may be made to the related art for a specific procedure.

It can be seen from the above embodiment that when an IAB-node performs migration, a conditional reconfiguration mechanism is appropriately introduced, which may reduce the time of service interruption and improve user experiences. In addition, the parent IAB-node determines the conditional reconfiguration strategy, which enables faster configuration of conditional reconfiguration and further reduces the time of service interruption.

### Embodiment 6

The embodiment of this disclosure provides a method for conditional reconfiguration, applicable to at least one of a first IAB-node, a child IAB-node of the first IAB-node and a terminal equipment served by the first IAB-node or the child IAB-node as well as a source parent IAB-node of the first IAB-node, i.e. a second IAB-node.

In the embodiment of this disclosure, the first IAB-node is a migration IAB-node, and the second IAB-node is the source parent IAB-node of the first IAB-node.

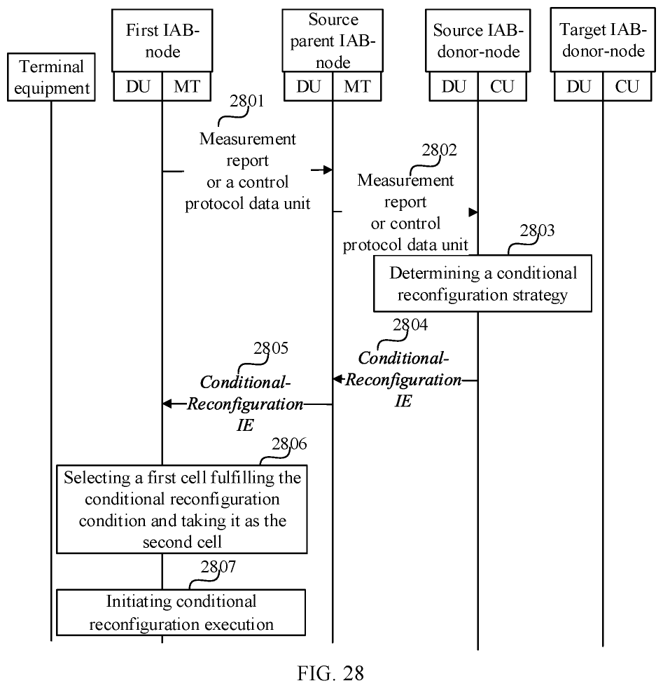

FIG. 28 is a schematic diagram of the method for conditional reconfiguration of embodiment 6 of this disclosure. As shown in FIG. 28, the method includes:
step 2801: transmitting a measurement report or a control protocol data unit for flow control feedback by the first IAB-node to the source parent IAB-node;
step 2802: transmitting the measurement report or control protocol data unit for flow control feedback by the source parent IAB-node to the source IAB-donor-node;
step 2803: determining a conditional reconfiguration strategy by the source IAB-donor-node according to the measurement report or the control protocol data unit or flow control feedback;
step 2804: transmitting ConditionalReconfiguration IE by the source IAB-donor-node to the source parent IAB-node;
step 2805: transmitting ConditionalReconfiguration IE by the source parent IAB-node to the first IAB-node;
step 2806: selecting a first cell fulfilling the conditional reconfiguration condition by the IAB-MT of the first IAB-node from conditional reconfiguration candidate cells and taking it as the second cell; and
step 2807: initiating conditional reconfiguration execution on the second cell by the IAB-MT of the first IAB-node.

In the embodiment of this disclosure, the measurement report transmitted by the first IAB-node to the source parent IAB-node may be from an IAB-MT of the first IAB-node, or an IAB-MT of a child IAB-node of the first IAB-node, or a terminal equipment served by the first IAB-node or the child IAB-node.

In the embodiment of this disclosure, the control protocol data unit for flow control feedback transmitted by the first IAB-node to the source parent IAB-node may be from the IAB-MT of the first IAB-node or the IAB-MT of the child IAB-node of the first IAB-node.

In step 2801, the measurement report or the control protocol data unit may be transmitted and received via a BH link.

In step 2802, the measurement report or the control protocol data unit may be transmitted to the source IAB-donor-node of the first IAB-node via an F1 interface.

In the embodiment of this disclosure, for the intra-IAB-donor-CU (intra-CU) migration, the source IAB-donor-node and the target IAB-donor-node are the same donor-node, and for the inter-IAB-donor-CU (inter-CU) migration, the source IAB-donor-node and the target IAB-donor-node are different donor nodes.

In the embodiment of this disclosure, the CU of the IAB-donor-node of the first IAB-node controls the IAB-MT of the first IAB-node or the IAB-MT of the child IAB-node or the terminal equipment to apply the method of conditional reconfiguration of the embodiment of this disclosure.

For example, the CU controls as per IAB-MT or as per terminal equipment, or the CU controls based on the conditional reconfiguration condition, or the CU controls based on a conditional reconfiguration candidate cell.

For example, that the CU controls as per IAB-MT or as per terminal equipment includes that the CU configures an IAB-node or terminal equipment, and allows for executing the method of conditional reconfiguration.

For example, that the CU controls based on the conditional reconfiguration condition includes that when the CU configures at least one conditional reconfiguration condition belonging to a first group of conditions for an IAB-node or terminal equipment and allows the IAB-node or terminal equipment to execute the method of conditional reconfiguration based on the at least one conditional reconfiguration condition to determine whether to initiate conditional reconfiguration execution, the method of conditional reconfiguration is executed.

For example, the first group of conditions includes at least one of the following conditions that: a radio link failure of a link with its parent IAB-node is detected; a notification of a radio link failure from the parent IAB-node is received; a first indication triggering conditional reconfiguration from the parent IAB-node is received; and a second indication of flow control from the parent IAB-node is received.

For example, the CU controls via RRC configuration and/or F1 configuration.

For example, that the CU controls via RRC configuration includes that when an added optional field of an ENUMERATED type in an ConditionalReconfiguration IE is present, it is determined that an IAB-node or terminal equipment executes the method of conditional reconfiguration; and/or, when an added optional field of an ENUMERATED type in CondReconfigToAddMod-r 16 of IE CondReconfigToAddModList is present, for a corresponding target candidate cell and/or a conditional reconfiguration condition, it is determined that an IAB-node or terminal equipment executes the method of conditional reconfiguration of the embodiment of this disclosure.

It can be seen from the above embodiment that when an IAB-node performs migration, a conditional reconfiguration mechanism is appropriately introduced, which may reduce the time of service interruption and improve user experiences. In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 7

The embodiment of this disclosure provides an apparatus for conditional reconfiguration, applicable to at least one of a first IAB-node, a child IAB-node of the first IAB-node and a terminal equipment served by the first IAB-node or the child IAB-node. The apparatus corresponds to the method of embodiment 1.

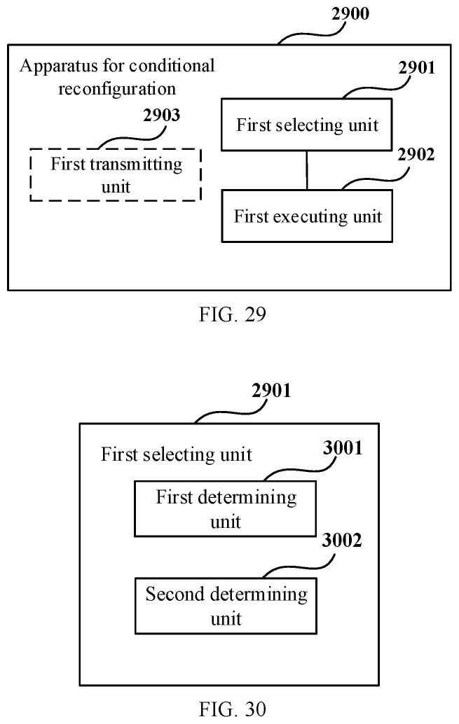

FIG. 29 is a schematic diagram of the apparatus for conditional reconfiguration of embodiment 7 of this disclosure. As shown in FIG. 29, an apparatus 2900 includes:
a first selecting unit 2901 configured to select one of first cell(s) fulfilling conditional reconfiguration condition(s) from conditional reconfiguration candidate cells as a second cell; and
a first executing unit 2902 configured to initiate conditional reconfiguration execution on the second cell.

FIG. 30 is a schematic diagram of the first selecting unit of embodiment 7 of this disclosure. As shown in FIG. 30, the first selecting unit 2901 includes:
a first determining unit 3001 configured to, when there exists a first cell fulfilling the conditional reconfiguration condition, take the first cell as the second cell; and
a second determining unit 3002 configured to, when there exist at least two first cells fulfilling the conditional reconfiguration condition, determine a first cell as the second cell.

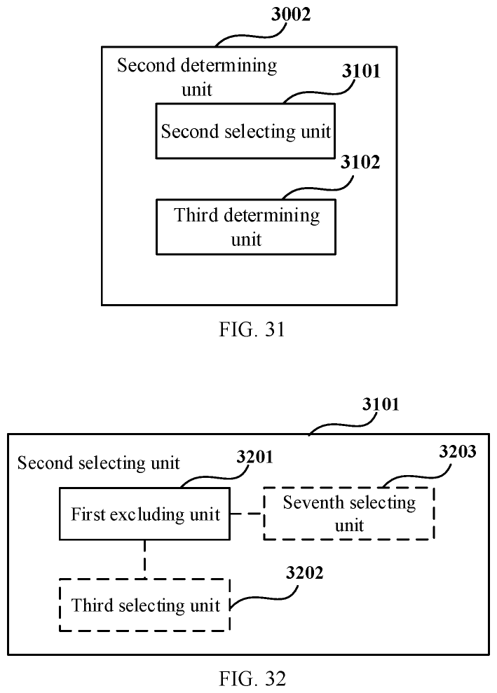

FIG. 31 is a schematic diagram of the second determining unit of embodiment 7 of this disclosure. As shown in FIG. 31, the second determining unit 3002 includes:
a second selecting unit 3101 configured to select a first cell from the at least two first cells and take it as the second cell; or
a third determining unit 3102 configured to take a first cell appearing first or last in stored information on conditional reconfiguration as the second cell.

FIG. 32 is a schematic diagram of the second selecting unit of embodiment 7 of this disclosure. As shown in FIG. 32, the second selecting unit 3101 includes:
a first excluding unit 3201 configured to exclude at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node.

As shown in FIG. 32, the second selecting unit 3101 may further include:
a third selecting unit 3202 configured to select a first cell as the second cell based on implementation in the first cells after exclusion. As shown in FIG. 32, alternative to the third selecting unit 3202, the second selecting unit 3101 may further include:
a seventh selecting unit 3203 configured to select a first cell fulfilling a second condition from the first cells after exclusion and take it as the second cell,
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and

The first cell with T beams or reference signals having best average quality.

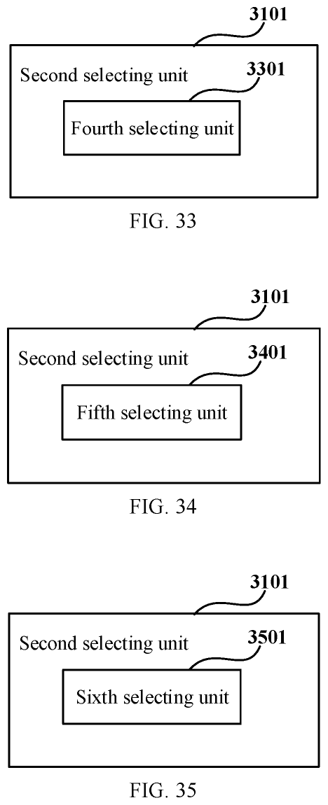

FIG. 33 is another schematic diagram of the second selecting unit of embodiment 7 of this disclosure. As shown in FIG. 33, the second selecting unit 3101 includes:
a fourth selecting unit 3301 configured to select a first cell fulfilling at least one of the following conditions from the at least two first cells and take it as the second cell:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

FIG. 34 is a further schematic diagram of the second selecting unit of embodiment 7 of this disclosure. As shown in FIG. 34, the second selecting unit 3101 includes:
a fifth selecting unit 3401 configured to, based on implementation, select a first cell fulfilling a first condition from the at least two first cells and take it as the second cell,
the first condition including at least one of the following conditions:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

FIG. 35 is still another schematic diagram of the second selecting unit of embodiment 7 of this disclosure. As shown in FIG. 35, the second selecting unit 3101 includes:
a sixth selecting unit 3501 configured to select a first cell fulfilling a second condition from the at least two first cells and take it as the second cell,
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and

The first cell with T beams or reference signals having best average quality.

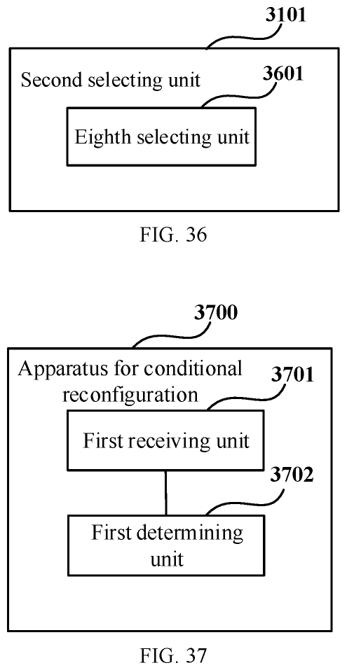

FIG. 36 is yet another schematic diagram of the second selecting unit of embodiment 7 of this disclosure. As shown in FIG. 36, the second selecting unit 3101 includes:
an eighth selecting unit 3601configured to select a first cell fulfilling a first condition and a second condition from the at least two first cells and take it as the second cell,
the first condition including at least one of the following that:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node;
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and

The first cell with T beams or reference signals having best average quality.

In the embodiment of this disclosure, reference may be made the implementations of the steps in embodiment 1 for implementations of functions of the above units, which shall not be repeated herein any further.

It can be seen from the above embodiment that when an IAB-node performs migration, a conditional reconfiguration mechanism is appropriately introduced, which may reduce the time of service interruption and improve user experiences.

### Embodiment 8

The embodiment of this disclosure provides an apparatus for conditional reconfiguration, applicable to a second IAB-node, the second IAB-node being a source parent IAB-node of a first IAB-node. The apparatus corresponds to the method of embodiment 2.

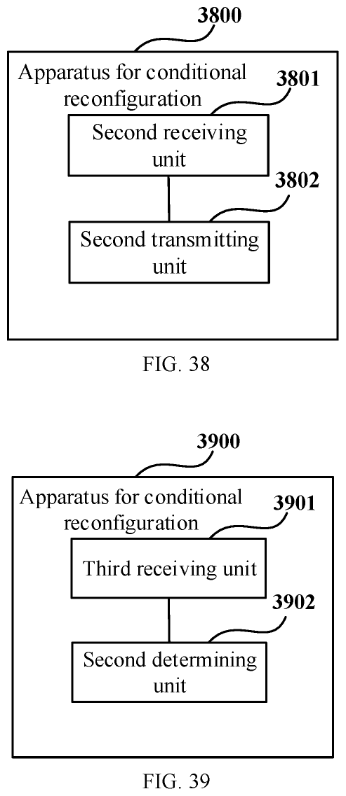

FIG. 37 is a schematic diagram of the apparatus for conditional reconfiguration of embodiment 8 of this disclosure. As shown in FIG. 37, an apparatus 3700 includes:
a first receiving unit 3701 configured to receive a measurement report or a control protocol data unit (PDU) for flow control feedback; and
a first determining unit 3702 configured to determine a conditional reconfiguration strategy according to the measurement report or the control protocol data unit.

In the embodiment of this disclosure, the measurement report may be from an IAB-MT of the first IAB-node, or an IAB-MT of a child IAB-node of the first IAB-node, or a terminal equipment served by the first IAB-node or the child IAB-node.

In the embodiment of this disclosure, the control protocol data unit may be from the IAB-MT of the first IAB-node or the IAB-MT of the child IAB-node of the first IAB-node.

In this embodiment, reference may be made to the implementations of the steps in embodiment 2 and embodiment 1 for implementations of functions of the above units, which shall not be repeated herein any further.

It can be seen from the above embodiment that when an IAB-node performs migration, a conditional reconfiguration mechanism is appropriately introduced, which may reduce the time of service interruption and improve user experiences. In addition, the parent IAB-node determines the conditional reconfiguration strategy, which enables faster configuration of conditional reconfiguration and further reduces the time of service interruption.

### Embodiment 9

The embodiment of this disclosure provides an apparatus for conditional reconfiguration, applicable to a second IAB-node, the second IAB-node being a source parent IAB-node of a first IAB-node. The apparatus corresponds to the method of embodiment 3.

FIG. 38 is a schematic diagram of the apparatus for conditional reconfiguration of embodiment 9 of this disclosure. As shown in FIG. 38, an apparatus 3800 includes:
a second receiving unit 3801 configured to receive a measurement report or a control protocol data unit for flow control feedback; and
a second transmitting unit 3802 configured to transmit the measurement report or the control protocol data unit to the source IAB-donor-node of the first IAB-node.

In the embodiment of this disclosure, the measurement report may be from an IAB-MT of the first IAB-node, or an IAB-MT of a child IAB-node of the first IAB-node, or a terminal equipment served by the first IAB-node or the child IAB-node.

In the embodiment of this disclosure, the control protocol data unit may be from the IAB-MT of the first IAB-node or the IAB-MT of the child IAB-node of the first IAB-node.

In the embodiment of this disclosure, the measurement report or the control protocol data unit may be received via a BH link.

In the embodiment of this disclosure, the measurement report or the control protocol data unit may be transmitted to the source IAB-donor-node of the first IAB-node via an F1 interface.

In the embodiment of this disclosure, reference may be made to the implementations of the steps in embodiment 3 and embodiment 1 for implementations of functions of the above units, which shall not be repeated herein any further.

It can be seen from the above embodiment that when an IAB-node performs migration, a conditional reconfiguration mechanism is appropriately introduced, which may reduce the time of service interruption and improve user experiences. In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 10

The embodiment of this disclosure provides an apparatus for conditional reconfiguration, applicable to a source IAB-donor-node of a first IAB-node. The apparatus corresponds to the method of embodiment 4.

FIG. 39 is a schematic diagram of the apparatus for conditional reconfiguration of embodiment 10 of this disclosure. As shown in FIG. 39, an apparatus 3900 includes:
a third receiving unit 3901 configured to receive a measurement report or a control protocol data unit for flow control feedback or a downlink data transmission state protocol data unit or a notification of a radio link failure; and
a second determining unit 3902 configured to determine a conditional reconfiguration strategy according to the measurement report or the control protocol data unit for flow control feedback or the downlink data transmission state protocol data unit or the notification of a radio link failure.

In the embodiment of this disclosure, the measurement report may be from an IAB-MT of the first IAB-node or an IAB-MT of a child IAB-node of the first IAB-node or a terminal equipment served by the first IAB-node or served by the child IAB-node of the first IAB-node

In the embodiment of this disclosure, the control protocol data unit may be from the IAB-MT of the first IAB-node or the IAB-MT of the child IAB-node of the first IAB-node.

In the embodiment of this disclosure, the downlink data transmission state protocol data unit may be from the parent IAB-node or an access IAB-node of the terminal equipment served by the first IAB-node or served by the child IAB-node of the first IAB-node.

In the embodiment of this disclosure, the notification of a radio link failure may be from the parent IAB-node or an access IAB-node of the terminal equipment served by the first IAB-node or served by the child IAB-node of the first IAB-node.

In the embodiment of this disclosure, the measurement report or the control protocol data unit or the downlink data transmission state protocol data unit or the notification of a radio link failure may be received via an F1 interface.

In the embodiment of this disclosure, reference may be made to the implementations of the steps in embodiment 4 and embodiment 1 for implementations of functions of the above units, which shall not be repeated herein any further.

It can be seen from the above embodiment that when an IAB-node performs migration, a conditional reconfiguration mechanism is appropriately introduced, which may reduce the time of service interruption and improve user experiences. In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 11

The embodiment of this disclosure provides a terminal equipment, including the apparatus for conditional reconfiguration as described in embodiment 7.

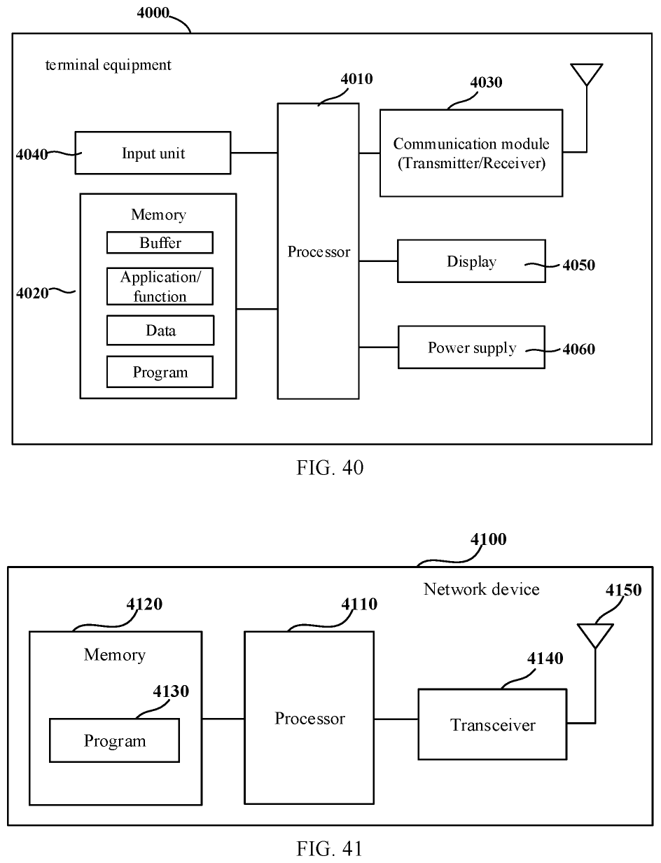

FIG. 40 is a block diagram of a systematic structure of the terminal equipment of embodiment 11 of this disclosure. As shown in FIG. 40, a terminal equipment 4000 may include a processor 4010 and a memory 4020, the memory 4020 being coupled to the processor 4010. It should be noted that this figure is illustrative only, and other types of structures may also be used, so as to supplement or replace this structure and achieve a telecommunications function or other functions.

In one implementation, the functions of the apparatus for conditional reconfiguration may be integrated into the processor 4010. The processor 4010 may be configured to: select one of first cell(s) fulfilling conditional reconfiguration condition(s) from conditional reconfiguration candidate cells as a second cell; and initiate conditional reconfiguration execution on the second cell.

In another implementation, the apparatus for conditional reconfiguration and the processor 4010 may be configured separately; for example, the apparatus for conditional reconfiguration may be configured as a chip connected to the processor 4010, and the functions of the apparatus for conditional reconfiguration are executed under control of the processor 4010.

As shown in FIG. 40, the terminal equipment 4000 may further include a communication module 4030, an input unit 4040, a display 4050 and a power supply 4060. It should be noted that the terminal equipment 4000 does not necessarily include all the parts shown in FIG. 40. Furthermore, the terminal equipment 4000 may include parts not shown in FIG. 40, and the related art may be referred to.

As shown in FIG. 40, the processor 4010 is sometimes referred to as a controller or an operational control, which may include a microprocessor or other processor devices and/or logic devices. The processor 4010 receives input and controls operations of components of the terminal equipment 4000.

The memory 4020 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 4010 may execute programs stored in the memory 4020, so as to realize information storage or processing, etc. Functions of other parts are similar to those of the related art, which shall not be described herein any further. The parts of the terminal equipment 4000 may be realized by specific hardware, firmware, software, or any combination thereof, without departing from the scope of this disclosure.

It can be seen from the above embodiment that when an IAB-node performs migration, a conditional reconfiguration mechanism is appropriately introduced, which may reduce the time of service interruption and improve user experiences.

### Embodiment 12

The embodiment of this disclosure provides a network device, including the apparatus for conditional reconfiguration as described in embodiment 7 or 8 or 9 or 10.

FIG. 41 is a schematic diagram of a systematic structure of the network device of Embodiment 12 of this disclosure. As shown in FIG. 41, a network device 4100 may include a processor 4110 and a memory 4120, the memory 4120 being coupled to the processor 4110. The memory 4120 may store various data, and furthermore, it may store a program 4130 for data processing, and execute the program 4130 under control of the processor 4110, so as to receive various information transmitted by a terminal equipment, and transmit various information to the terminal equipment.

In one implementation, the functions of the apparatus for conditional reconfiguration may be integrated into the processor 4110.

Corresponding to embodiment 7, the processor 4110 may be configured to: select one of first cell(s) fulfilling conditional reconfiguration condition(s) from conditional reconfiguration candidate cells as a second cell; and initiate conditional reconfiguration execution on the second cell.

Corresponding to embodiment 8, the processor 4110 may be configured to: receive a measurement report or a control protocol data unit (PDU) for flow control feedback; and determine a conditional reconfiguration strategy according to the measurement report or the control protocol data unit.

Corresponding to embodiment 9, the processor 4110 may be configured to: receive a measurement report or a control protocol data unit for flow control feedback; and transmit the measurement report or the control protocol data unit to the source IAB-donor-node of the first IAB-node.

Corresponding to embodiment 10, the processor 4110 may be configured to: receive a measurement report or a control protocol data unit for flow control feedback or a downlink data transmission state protocol data unit or a notification of a radio link failure; and determine a conditional reconfiguration strategy according to the measurement report or the control protocol data unit for flow control feedback or the downlink data transmission state protocol data unit or the notification of a radio link failure.

In another implementation, the apparatus for conditional reconfiguration and the processor 4110 may be configured separately; for example, the apparatus for conditional reconfiguration may be configured as a chip connected to the processor 4110, and the functions of the apparatus for conditional reconfiguration are executed under control of the processor 4110.

Furthermore, as shown in FIG. 41, the network device 4100 may include a transceiver 4140, and an antenna 4150, etc. Functions of the above components are similar to those in the related art, and shall not be described herein any further. It should be noted that the network device 4100 does not necessarily include all the parts shown in FIG. 41. Furthermore, the network device 4100 may include parts not shown in FIG. 41, and the related art may be referred to.

It can be seen from the above embodiment that when an IAB-node performs migration, a conditional reconfiguration mechanism is appropriately introduced, which may reduce the time of service interruption and improve user experiences.

In addition, the parent IAB-node determines the conditional reconfiguration strategy, which enables faster configuration of conditional reconfiguration and further reduces the time of service interruption.

In addition, the IAB-donor determines the conditional reconfiguration strategy, which may take the entire topology situation into account, and provide information on better conditional reconfiguration for the IAB-node, thereby improving a success rate of conditional reconfiguration execution.

In addition, the IAB-donor determines the conditional reconfiguration strategy, which may take the entire topology situation into account, and provide information on better conditional reconfiguration for the IAB-node, thereby improving a success rate of conditional reconfiguration execution.

### Embodiment 13

The embodiment of this disclosure provides a communication system, including the terminal equipment described in Embodiment 11 and/or the network device described in Embodiment 12.

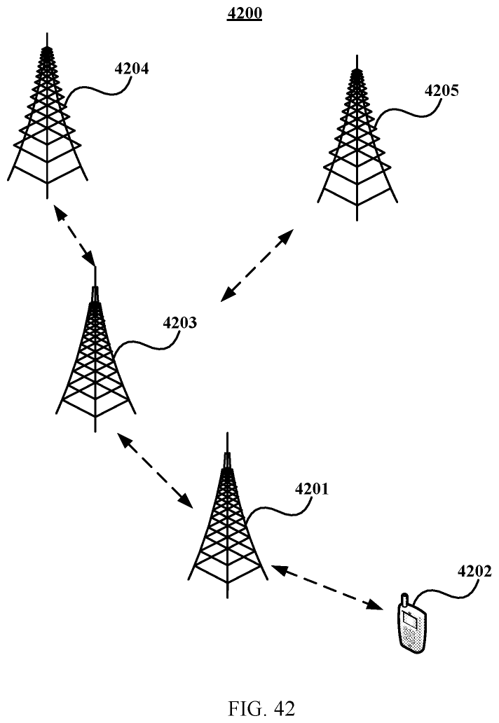

FIG. 42 is a schematic diagram of the communication system of embodiment 1 3 of this disclosure. As shown in FIG. 42, in a scenario of inter-CU migration, a communication system 4200 includes a first IAB-node 4201 as a migrating node, a terminal equipment 4202 served by the first IAB-node 4201, a parent IAB-node 4203 of the first IAB-node 4201, a source IAB-donor-node 4204 and a target IAB-donor-node 4205.

For example, the terminal equipment 4202 and/or the first IAB-node 4201 may include the apparatus described in embodiment 7, and the parent IAB-node 4203 may include the apparatus described in embodiment 8.

Or, for another example, the terminal equipment 4202 and/or the first IAB-node 4201 may include the apparatus described in embodiment 7, the parent IAB-node 4203 may include the apparatus described in embodiment 9, and the source IAB-donor-node 4204 may include the apparatus described in embodiment 10.

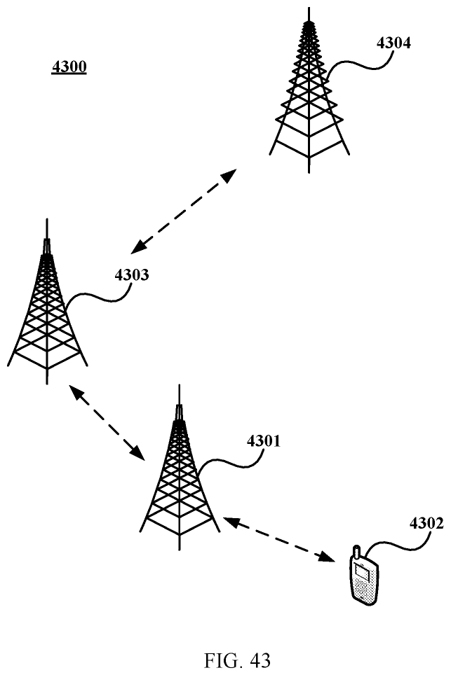

FIG. 43 is another schematic diagram of the communication system of embodiment 13 of this disclosure. As shown in FIG. 43, in a scenario of intra-CU migration, a communication system 4300 includes a first IAB-node 4301 as a migrating node, a terminal equipment 4302 served by the first IAB-node 4301, a parent IAB-node 4303 of the first IAB-node 4301 and an IAB-donor-node 4304.

For example, the terminal equipment 4302 and/or the first IAB-node 4301 may include the apparatus described in embodiment 7, and parent IAB-node 4303 may include the apparatus described in embodiment 8.

Or, for another example, the terminal equipment 4302 and/or the first IAB-node 4301 may include the apparatus described in embodiment 7, the parent IAB-node 4303 may include the apparatus described in embodiment 9, and the IAB-donor-node 4304 may include the apparatus described in embodiment 10.

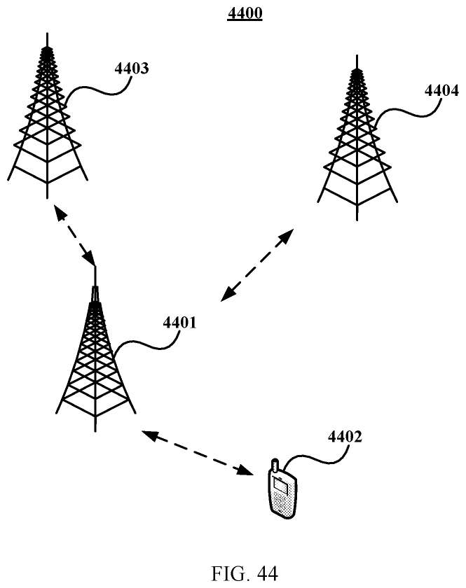

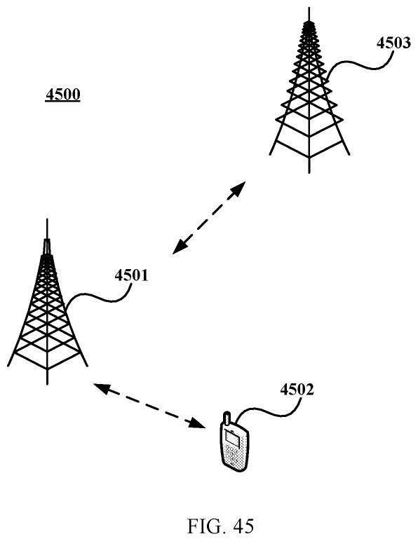

FIG. 44 is a further schematic diagram of the communication system of embodiment 13 of this disclosure. As shown in FIG. 44, in a scenario of inter-CU migration, a communication system 4400 includes a first IAB-node 4401 as a migrating node, a terminal equipment 4402 served by the first IAB-node 4401, a source IAB-donor-node 4403 and a target IAB-donor-node 4404.

For example, the terminal equipment 4402 and/or the first IAB-node 4401 may include the apparatus described in embodiment 7, and the source IAB-donor-node 4403 may include the apparatus described in embodiment 10.

FIG. 45 is still another schematic diagram of the communication system of embodiment 13 of this disclosure. As shown in FIG. 45, in a scenario of intra-CU migration, a communication system 4500 includes a first IAB-node 4501 as a migrating node, a terminal equipment 4502 served by the first IAB-node 4501, and an IAB-donor-node 4503.

For example, the terminal equipment 4502 and/or the first IAB-node 4501 may include the apparatus described in embodiment 7, and the IAB-donor-node 4503 may include the apparatus described in embodiment 10.

What described above are some examples of IAB architectures applying the methods and apparatuses for conditional reconfiguration, which are also applicable to structures of communication systems under other IAB architectures.

For example, the communication system further includes a child IAB-node of the first IAB-node and a terminal equipment served by the child IAB-node, and the child IAB-node and the terminal equipment served by the child IAB-node may also include the apparatus described in embodiment 7.

It can be seen from the above embodiment that when an IAB-node performs migration, a conditional reconfiguration mechanism is appropriately introduced, which may reduce the time of service interruption and improve user experiences.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 29 may either correspond to software modules of procedures of a computer program, or correspond to hardware modules. Such software modules may respectively correspond to the steps shown in FIG. 9. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 29 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 29 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

According to the implementations disclosed in the embodiments, following supplements are further disclosed.
Supplement I
1. An apparatus for conditional reconfiguration, applicable to at least one of a first IAB-node, a child IAB-node of the first IAB-node and a terminal equipment served by the first IAB-node or the child IAB-node,
the apparatus comprising:
a first selecting unit configured to select one of first cell(s) fulfilling conditional reconfiguration condition(s) from conditional reconfiguration candidate cells as a second cell; and
a first executing unit configured to initiate conditional reconfiguration execution on the second cell.
2. The apparatus according to supplement 1, wherein,
the conditional reconfiguration condition comprises at least one of the following conditions that:
a radio link failure of a link with its parent IAB-node is detected;
a notification of a radio link failure from the parent IAB-node is received;
a first indication triggering conditional reconfiguration from the parent IAB-node is received;
a second indication of flow control from the parent IAB-node is received;
quality of a conditional reconfiguration candidate cell becomes better than a PCell and/or a PSCell or quality of a conditional reconfiguration candidate cell becomes offset better than a PCell and/or a PSCell;
quality of a PCell and/or a PSCell becomes worse than a first threshold and quality of a conditional reconfiguration candidate cell becomes better than a second threshold; and
quality of a conditional reconfiguration candidate cell becomes better than a third threshold or quality of a conditional reconfiguration candidate cell becomes offset better than a third threshold.
3. The apparatus according to supplement 2, wherein,
the notification of a radio link failure and/or the first indication is/are received via a PDU control BAP; or
the notification of a radio link failure and/or the first indication is/are received via a system message; or
the notification of a radio link failure and/or the first indication is/are received via a paging message.
4. The apparatus according to supplement 3, wherein,
at least one of the notification of a radio link failure, the first indication and an update indication of the system message is comprised in a short message of paging message and is indicated by DCI.
5. The apparatus according to any one of supplements 2-4, wherein,
the notification of a radio link failure comprises at least one of a Type-4 RLF (radio link failure) notification, a Type-2 RLF (radio link failure) notification and a Type-3 RLF (radio link failure) notification.
6. The apparatus according to supplement 2, wherein that a second indication of flow control from the parent IAB-node is received comprises that:
a second indication based on an available buffer size or based on a buffer overload is received.
7. The apparatus according to supplement 6, wherein,
the second indication includes information indicating the available buffer size and/or information indicating buffer overload of the parent IAB-node.
8. The apparatus according to supplement 6 or 7, wherein that a second indication based on an available buffer size is received comprises that:
the second indication based on an available buffer size is received and an available buffer size denoted by information on the available buffer size is greater than a fourth threshold.
9. The apparatus according to supplement 1, wherein the first selecting unit comprises:
a first determining unit configured to, when a first cell fulfilling the conditional reconfiguration condition exists, consider the first cell as the second cell; and
a second determining unit configured to, when at least two first cells fulfilling the conditional reconfiguration condition exist, determine one of first cells as the second cell.
10. The apparatus according to supplement 9, wherein the second determining unit comprises:
a second selecting unit configured to select a first cell from the at least two first cells as the second cell; or
a third determining unit configured to consider a first cell appearing first or last in stored information on conditional reconfiguration as the second cell.
11. The apparatus according to supplement 10, wherein the second selecting unit comprises:
a first excluding unit configured to exclude at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node.
12. The apparatus according to supplement 11, wherein the second selecting unit further comprises:
a third selecting unit configured to select a first cell as the second cell based on implementation in the first cells after exclusion.
13. The apparatus according to supplement 10, wherein the second selecting unit comprises:
a fourth selecting unit configured to select a first cell fulfilling at least one of the following conditions from the at least two first cells and take it as the second cell:
when a radio link failure withwith its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.
14. The apparatus according to supplement 10, wherein the second selecting unit comprises:
a fifth selecting unit configured to, based on implementation, select a first cell fulfilling a first condition from the at least two first cells and take it as the second cell,
the first condition including at least one of the following conditions:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.
15. The apparatus according to supplement 10, wherein the second selecting unit comprises:
a sixth selecting unit configured to select a first cell fulfilling a second condition from the at least two first cells and take it as the second cell,
the second condition comprising at least one of the following that:
the first cell is a cell with a maximum number or a highest proportion of beams or reference signals whose quality better than a fifth threshold;
the first cell with best quality of a beam or a reference signal;
the first cell is a cell with a maximum number or a highest proportion of beams or reference signals in S beams or reference signals with best quality; and
The first cell with T beams or reference signals having best average quality.
16. The apparatus according to supplement 11, wherein the second selecting unit further comprises:
a seventh selecting unit configured to select a first cell fulfilling a second condition from the first cells after exclusion and take it as the second cell,
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and the first cell with T beams or reference signals having best average quality.
17. The apparatus according to supplement 10, wherein the second selecting unit comprises:
an eighth selecting unit configured to select a first cell fulfilling a first condition and a second condition from the at least two first cells and take it as the second cell,
the first condition comprising at least one of the following that:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node;
the second condition comprising at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.
18. The apparatus according to any one of supplements 15-17, wherein,
the quality includes RSRP of L1 layer, RSRQ of L1 layer, an SINR value of L1 layer, and at least one of RSRP, RSRQ and SINR value filtered by layer 3.
19. The apparatus according to supplement 1, wherein,
the first executing unit is configured to apply stored second cell configuration on the selected second cell.
20. The apparatus according to supplement 1, wherein,
a CU of an IAB-donor-node of the first IAB-node controls an IAB-MT of the first IAB-node or an IAB-MT of the child IAB-node or the terminal equipment to apply the apparatus for conditional reconfiguration.
21. The apparatus according to supplement 20, wherein,
the CU controls as per IAB-MT or as per terminal equipment, or
the CU controls based on the conditional reconfiguration condition, or
the CU controls based on a conditional reconfiguration candidate cell.
22. The apparatus according to supplement 21, wherein that the CU controls as per IAB-MT or as per terminal equipment includes that,
the CU configures an IAB-node or terminal equipment, and allows for executing the apparatus of conditional reconfiguration.
23. The apparatus according to supplement 21, wherein that the CU controls based on the conditional reconfiguration condition includes that,
when the CU configures at least one conditional reconfiguration condition belonging to a first group of conditions for an IAB-node or terminal equipment and allows the IAB-node or terminal equipment to determine whether to initiate conditional reconfiguration execution, the apparatus of conditional reconfiguration is executed,
the first group of conditions including at least one of the following conditions that:
a radio link failure of a link with its parent IAB-node is detected;
a notification of a radio link failure from the parent IAB-node is received;
a first indication triggering conditional reconfiguration from the parent IAB-node is received; and
a second indication of flow control from the parent IAB-node is received.
24. The apparatus according to supplement 20, wherein,
the CU controls via RRC configuration and/or F1 configuration.
25. The apparatus according to supplement 24, wherein that the CU controls via RRC configuration comprises that,
when an added optional field of an ENUMERATED type in an ConditionalReconfiguration IE is present, it is determined that an IAB-node or terminal equipment executes the method of conditional reconfiguration; and/or,
when an added optional field of an ENUMERATED type in CondReconfigToAddMod-r16 of IE CondReconfigToAddModList is present, for a corresponding target candidate cell and/or a conditional reconfiguration condition, it is determined that an IAB-node or terminal equipment executes the apparatus of conditional reconfiguration.
26. The apparatus according to any one of supplements 1-24, wherein the apparatus further comprises:
a first transmitting unit configured to transmit a measurement report or a control protocol data unit (PDU) for flow control feedback to its source parent IAB-node or to the source IAB-donor-node of the first IAB-node via the source parent IAB-node.
27. The apparatus according to supplement 26, wherein a conditional reconfiguration strategy is determined by the source parent IAB-node or the source IAB-donor-node.
28. The apparatus according to any one of supplements 1-27, wherein,
the conditional reconfiguration comprises conditional handover (CHO) or conditional PScell change.
29. The apparatus according to any one of supplements 1-28, wherein,
the conditional reconfiguration candidate cell is named as applicable cell.
30. The apparatus according to any one of supplements 1-29, wherein,
the conditional reconfiguration candidate cells comprise conditional handover (CHO) candidate cells and/or conditional PSCell change candidate cells.
31. An apparatus for conditional reconfiguration, applicable to a second IAB-node, the second IAB-node being a source parent IAB-node of a first IAB-node,
the apparatus comprising:
a first receiving unit configured to receive a measurement report or a control protocol data unit (PDU) for flow control feedback; and
a first determining unit configured to determine a conditional reconfiguration strategy according to the measurement report or the control protocol data unit.
32. The apparatus according to supplement 31, wherein,
the measurement report is from an IAB-MT of the first IAB-node, or an IAB-MT of a child IAB-node of the first IAB-node, or a terminal equipment served by the first IAB-node or the child IAB-node.
33. The apparatus according to supplement 31, wherein,
the control protocol data unit is from the IAB-MT of the first IAB-node or the IAB-MT of the child IAB-node of the first IAB-node.
34. An apparatus for conditional reconfiguration, applicable to a second IAB-node, the second IAB-node being a source parent IAB-node of a first IAB-node,
the apparatus comprising:
a second receiving unit configured to receive a measurement report or a control protocol data unit for flow control feedback; and
a second transmitting unit configured to transmit the measurement report or the control protocol data unit to the source IAB-donor-node of the first IAB-node.
35. The apparatus according to supplement 34, wherein,
the measurement report is from an IAB-MT of the first IAB-node, or an IAB-MT of a child IAB-node of the first IAB-node, or a terminal equipment served by the first IAB-node or the child IAB-node.
36. The apparatus according to supplement 34, wherein,
the control protocol data unit is from the IAB-MT of the first IAB-node or the IAB-MT of the child IAB-node of the first IAB-node.
37. The apparatus according to any one of supplements 31-36, wherein,
the measurement report or the control protocol data unit is received via a BH link.
38. The apparatus according to any one of supplements 34-37, wherein,
the measurement report or the control protocol data unit is transmitted to the source IAB-donor-node of the first IAB-node via an F1 interface.
39. An apparatus for conditional reconfiguration, applicable to a source IAB-donor-node of a first IAB-node,
the apparatus comprising:
a third receiving unit configured to receive a measurement report or a control protocol data unit for flow control feedback or a downlink data transmission state protocol data unit or a notification of a radio link failure; and
a second determining unit configured to determine a conditional reconfiguration strategy according to the measurement report or the control protocol data unit for flow control feedback or the downlink data transmission state protocol data unit or the notification of a radio link failure.
40. The apparatus according to supplement 39, wherein,
the measurement report is from an IAB-MT of a first IAB-node, or an IAB-MT of a child IAB-node of the first IAB-node, or a terminal equipment served by the first IAB-node or the child IAB-node.
41. The apparatus according to supplement 39, wherein,
the control protocol data unit is from the IAB-MT of the first IAB-node or the IAB-MT of the child IAB-node of the first IAB-node.
42. The apparatus according to supplement 39, wherein,
the downlink data transmission state protocol data unit is from a parent IAB-node of the first IAB-node or an access IAB-node of a terminal equipment served by the first IAB-node or served by the child IAB-node of the first IAB-node.
43. The apparatus according to supplement 39, wherein,
the notification of a radio link failure is from a parent IAB-node of the first IAB-node or an access IAB-node of the terminal equipment served by the first IAB-node or served by the child IAB-node of the first IAB-node.
44. The apparatus according to any one of supplements 39-43, wherein,
the measurement report or the control protocol data unit or the downlink data transmission state protocol data unit or the notification of a radio link failure is received via an F1 interface.
45. A terminal equipment, comprising the apparatus as described in any one of supplements 1-33.
46. A network device, the network device being a first IAB-node or a child IAB-node of the first IAB-node, and the network device comprising the apparatus as described in any one of supplements 1-33.
47. A network device, the network device being a second IAB-node, the second IAB-node being a source parent IAB-node of the first IAB-node, and the network device comprising the apparatus as described in any one of supplements 31-33.
48. A network device, the network device being a second IAB-node, the second IAB-node being a source parent IAB-node of the first IAB-node, and the network device comprising the apparatus as described in any one of supplements 34-38.
49. A network device, the network device being a source IAB-donor-node of a first IAB-node, and the network device comprising the apparatus as described in any one of supplements 39-44.
50. A communication system, comprising at least one of the terminal equipment as described in supplement 45, the network device as described in supplement 46 and the network device as described in supplement 47.
51. A communication system, comprising at least one of the terminal equipment as described in supplement 45, the network device as described in supplement 46, the network device as described in supplement 48 and the network device as described in supplement 49.

Supplement II
1. A method for conditional reconfiguration, applicable to at least one of a first IAB-node, a child IAB-node of the first IAB-node and a terminal equipment served by the first IAB-node or the child IAB-node,
the method comprising:
selecting a first cell fulfilling a conditional reconfiguration condition from conditional reconfiguration candidate cells and taking the first cell as a second cell; and initiating conditional reconfiguration execution on the second cell.
2. The method according to supplement 1, wherein,
the conditional reconfiguration condition comprises at least one of the following conditions that:
a radio link failure of a link with its parent IAB-node is detected;
a notification of a radio link failure from the parent IAB-node is received;
a first indication triggering conditional reconfiguration from the parent IAB-node is received;
a second indication of flow control from the parent IAB-node is received;
quality of a conditional reconfiguration candidate cell becomes better than a PCell and/or a PSCell or quality of a conditional reconfiguration candidate cell becomes offset better than a PCell and/or a PSCell;
quality of a PCell and/or a PSCell becomes worse than a first threshold and quality of a conditional reconfiguration candidate cell becomes better than a second threshold; and
quality of a conditional reconfiguration candidate cell becomes better than a third threshold or quality of a conditional reconfiguration candidate cell becomes offset better than a third threshold.
3. The method according to supplement 2, wherein,
the notification of a radio link failure and/or the first indication is/are received via a PDU control BAP; or
the notification of a radio link failure and/or the first indication is/are received via a system message; or
the notification of a radio link failure and/or the first indication is/are received via a paging message.
4. The method according to supplement 3, wherein,
at least one of the notification of a radio link failure, the first indication and an update indication of the system message is comprised in a short message of paging message and is indicated by DCI.
5. The method according to any one of supplements 2-4, wherein,
the notification of a radio link failure comprises at least one of a Type-4 RLF (radio link failure) notification, a Type-2 RLF (radio link failure) notification and a Type-3 RLF (radio link failure) notification.
6. The method according to supplement 2, wherein that a second indication of flow control from the parent IAB-node is received comprises that:
a second indication based on an available buffer size or based on a buffer overload is received.
7. The method according to supplement 6, wherein,
the second indication includes information indicating the available buffer size and/or information indicating buffer overload of the parent IAB-node.
8. The method according to supplement 6 or 7, wherein that a second indication based on an available buffer size is received comprises that:
the second indication based on an available buffer size is received and an available buffer size denoted by information on the available buffer size is greater than a fourth threshold.
9. The method according to supplement 1, wherein the selecting a first cell fulfilling a conditional reconfiguration condition from conditional reconfiguration candidate cells and taking the first cell as a second cell comprise:
when there exists a first cell fulfilling the conditional reconfiguration condition, taking the first cell as the second cell; and
when there exist at least two first cells fulfilling the conditional reconfiguration condition, determining a first cell as the second cell.
10. The method according to supplement 9, wherein the determining a first cell as the second cell comprises:
selecting a first cell from the at least two first cells and taking it as the second cell; or
taking a first cell appearing first or last in stored information on conditional reconfiguration as the second cell.
11. The method according to supplement 10, wherein the selecting a first cell from the at least two first cells and taking it as the second cell comprise:
excluding at least one of the following cells from the at least two first cells: a cell of the parent IAB-node when a failure of a radio link with its parent IAB-node is detected; cells of all IAB-nodes to which a parent IAB-node of the parent IAB-node is connected when a radio link failure notification is received from the parent IAB-node; and a cell of the parent IAB-node when the second indication of flow control is received from the parent IAB-node.
12. The method according to supplement 11, wherein the selecting a first cell from the at least two first cells and taking it as the second cell further comprise:
selecting a first cell as the second cell based on implementation in the first cells after exclusion.
13. The method according to supplement 10, wherein the selecting a first cell from the at least two first cells and taking it as the second cell comprise:
selecting a first cell fulfilling at least one of the following conditions from the at least two first cells and taking it as the second cell:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.
14. The method according to supplement 10, wherein the selecting a first cell from the at least two first cells and taking it as the second cell comprise:
based on implementation, selecting a first cell fulfilling a first condition from the at least two first cells and taking it as the second cell,
the first condition including at least one of the following conditions:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.
15. The method according to supplement 10, wherein the selecting a first cell from the at least two first cells and taking it as the second cell comprise:
selecting a first cell fulfilling a second condition from the at least two first cells and taking it as the second cell,
the second condition comprising at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.
16. The method according to supplement 11, wherein the selecting a first cell from the at least two first cells and taking it as the second cell comprise:
selecting a first cell fulfilling a second condition from the first cells after exclusion and taking it as the second cell,
the second condition including at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.
17. The method according to supplement 10, wherein the selecting a first cell from the at least two first cells and taking it as the second cell comprise:
selecting a first cell fulfilling a first condition and a second condition from the at least two first cells and taking it as the second cell,
the first condition comprising at least one of the following that:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node;
the second condition comprising at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.
18. The method according to any one of supplements 15-17, wherein,
the quality includes RSRP of L 1 layer, RSRQ of L1 layer, an SINR value of L 1 layer, and at least one of RSRP, RSRQ and SINR value filtered by layer 3.
19. The method according to supplement 1, wherein the initiating conditional reconfiguration execution on the second cell comprises:
applying stored second cell configuration on the selected second cell.
20. The method according to supplement 1, wherein,
a CU of an IAB-donor-node of the first IAB-node controls an IAB-MT of the first IAB-node or an IAB-MT of the child IAB-node or the terminal equipment to apply the method for conditional reconfiguration.
21. The method according to supplement 20, wherein,
the CU controls as per IAB-MT or as per terminal equipment, or
the CU controls based on the conditional reconfiguration condition, or
the CU controls based on a conditional reconfiguration candidate cell.
22. The method according to supplement 21, wherein that the CU controls as per IAB-MT or as per terminal equipment includes that,
the CU configures an IAB-node or terminal equipment, and allows for executing the method of conditional reconfiguration.
23. The method according to supplement 21, wherein that the CU controls based on the conditional reconfiguration condition includes that,
when the CU configures at least one conditional reconfiguration condition belonging to a first group of conditions for an IAB-node or terminal equipment and allows the IAB-node or terminal equipment to determine whether to initiate conditional reconfiguration execution, the method of conditional reconfiguration is executed,
the first group of conditions including at least one of the following conditions that:
a radio link failure of a link with its parent IAB-node is detected;
a notification of a radio link failure from the parent IAB-node is received;
a first indication triggering conditional reconfiguration from the parent IAB-node is received; and
a second indication of flow control from the parent IAB-node is received.
24. The method according to supplement 20, wherein,
the CU controls via RRC configuration and/or F1 configuration.
25. The method according to supplement 24, wherein that the CU controls via RRC configuration comprises that,
when an added optional field of an ENUMERATED type in an ConditionalReconfiguration IE is present, it is determined that an IAB-node or terminal equipment executes the method of conditional reconfiguration; and/or,
when an added optional field of an ENUMERATED type in CondReconfigToAddMod-r16 of IE CondReconfigToAddModList is present, for a corresponding target candidate cell and/or a conditional reconfiguration condition, it is determined that an IAB-node or terminal equipment executes the method of conditional reconfiguration.
26. The method according to any one of supplements 1-24, wherein the method further comprises:
transmitting a measurement report or a control protocol data unit (PDU) for flow control feedback to its source parent IAB-node or to the source IAB-donor-node of the first IAB-node via the source parent IAB-node.
27. The method according to supplement 26, wherein,
a conditional reconfiguration strategy is determined by the source parent IAB-node or the source IAB-donor-node.
28. The method according to any one of supplements 1-27, wherein,
the conditional reconfiguration comprises conditional handover (CHO) or conditional PScell change.
29. The method according to any one of supplements 1-28, wherein,
the conditional reconfiguration candidate cell is named as applicable cell.
30. The method according to any one of supplements 1-29, wherein,
the conditional reconfiguration candidate cells comprise conditional handover (CHO) candidate cells and/or conditional PSCell change candidate cells.
31. A method for conditional reconfiguration, applicable to a second IAB-node, the second IAB-node being a source parent IAB-node of a first IAB-node,
the method comprising:
receiving a measurement report or a control protocol data unit (PDU) for flow control feedback; and
determining a conditional reconfiguration strategy according to the measurement report or the control protocol data unit.
32. The method according to supplement 31, wherein,
the measurement report is from an IAB-MT of the first IAB-node, or an IAB-MT of a child IAB-node of the first IAB-node, or a terminal equipment served by the first IAB-node or the child IAB-node.
33. The method according to supplement 31, wherein,
the control protocol data unit is from the IAB-MT of the first IAB-node or the IAB-MT of the child IAB-node of the first IAB-node.
34. A method for conditional reconfiguration, applicable to a second IAB-node, the second IAB-node being a source parent IAB-node of a first IAB-node,
the method comprising:
receiving a measurement report or a control protocol data unit for flow control feedback; and
transmitting the measurement report or the control protocol data unit to the source IAB-donor-node of the first IAB-node.
35. The method according to supplement 34, wherein,
the measurement report is from an IAB-MT of the first IAB-node, or an IAB-MT of a child IAB-node of the first IAB-node, or a terminal equipment served by the first IAB-node or the child IAB-node.
36. The method according to supplement 34, wherein,
the control protocol data unit is from the IAB-MT of the first IAB-node or the IAB-MT of the child IAB-node of the first IAB-node.
37. The method according to any one of supplements 31-36, wherein,
the measurement report or the control protocol data unit is received via a BH link.
38. The method according to any one of supplements 34-37, wherein,
the measurement report or the control protocol data unit is transmitted to the source IAB-donor-node of the first IAB-node via an F1 interface.
39. A method for conditional reconfiguration, applicable to a source IAB-donor-node of a first IAB-node,
the method comprising:
receiving a measurement report or a control protocol data unit for flow control feedback or a downlink data transmission state protocol data unit or a notification of a radio link failure; and
determining a conditional reconfiguration strategy according to the measurement report or the control protocol data unit for flow control feedback or the downlink data transmission state protocol data unit or the notification of a radio link failure.
40. The method according to supplement 39, wherein,
the measurement report is from an IAB-MT of a first IAB-node, or an IAB-MT of a child IAB-node of the first IAB-node, or a terminal equipment served by the first IAB-node or the child IAB-node.
41. The method according to supplement 39, wherein,
the control protocol data unit is from the IAB-MT of the first IAB-node or the IAB-MT of the child IAB-node of the first IAB-node.
42. The method according to supplement 39, wherein,
the downlink data transmission state protocol data unit is from a parent IAB-node of the first IAB-node or an access IAB-node of a terminal equipment served by the first IAB-node or served by the child IAB-node of the first IAB-node.
43. The method according to supplement 39, wherein,
the notification of a radio link failure is from a parent IAB-node of the first IAB-node or an access IAB-node of the terminal equipment served by the first IAB-node or served by the child IAB-node of the first IAB-node.
44. The method according to any one of supplements 39-43, wherein,
the measurement report or the control protocol data unit or the downlink data transmission state protocol data unit or the notification of a radio link failure is received via an F1 interface.

1. An apparatus for conditional reconfiguration, applicable to at least one of a first IAB-node, a child IAB-node of the first IAB-node and a terminal equipment served by the first IAB-node or the child IAB-node,
the apparatus comprising:
a memory; and
a processor coupled to the memory and configured to:
select one of first cell(s) fulfilling conditional reconfiguration condition(s) from conditional reconfiguration candidate cells as a second cell; and
initiate conditional reconfiguration execution on the second cell.

2. The apparatus according to claim 1, wherein,
the conditional reconfiguration condition comprises at least one of the following conditions that:
a radio link failure of a link with its parent IAB-node is detected;
a notification of a radio link failure from the parent IAB-node is received;
quality of a conditional reconfiguration candidate cell becomes offset better than a PCell and/or a PSCell;
quality of a PCell and/or a PSCell becomes worse than a first threshold and quality of a conditional reconfiguration candidate cell becomes better than a second threshold; and
quality of a conditional reconfiguration candidate cell becomes better than a third threshold.

3. The apparatus according to claim 2, wherein,
the notification of a radio link failure and/or the first indication is/are received via a PDU control BAP; or
the notification of a radio link failure and/or the first indication is/are received via a system message; or
the notification of a radio link failure and/or the first indication is/are received via a paging message.

4. The apparatus according to claim 3, wherein,
at least one of the notification of a radio link failure, the first indication and an update indication of the system message is comprised in a short message of paging message and is indicated by DCI.

5. The apparatus according to claim 2, wherein,
the notification of a radio link failure comprises at least one of a Type-4 RLF (radio link failure) notification, a Type-2 RLF (radio link failure) notification and a Type-3 RLF (radio link failure) notification.

6. The apparatus according to claim 2, wherein that a second indication of flow control from the parent IAB-node is received comprises that:
a second indication based on an available buffer size or based on a buffer overload is received.

7. The apparatus according to claim 6, wherein that a second indication based on an available buffer size is received comprises that:
the second indication based on an available buffer size is received and an available buffer size denoted by information on the available buffer size is greater than a fourth threshold.

8. The apparatus according to claim 1, wherein the processor is further configured to:
when there exists the first cell fulfilling the conditional reconfiguration condition, take the first cell as the second cell; and
when there exist at least two first cells fulfilling the conditional reconfiguration condition, determine the first cell as the second cell.

9. The apparatus according to claim 8, wherein the processor is further configured to:
select the first cell from the at least two first cells and take it as the second cell; or
take the first cell appearing first or last in stored information on conditional reconfiguration as the second cell.

10. The apparatus according to claim 9, wherein the processor is further configured to:
select the first cell fulfilling at least one of the following conditions from the at least two first cells and take it as the second cell:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node.

11. The apparatus according to claim 9, wherein the processor is further configured to:
select the first cell fulfilling a second condition from the at least two first cells and take it as the second cell,
the second condition comprising at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.

12. The apparatus according to claim 9, wherein the processor is further configured to:
select the first cell fulfilling a first condition and a second condition from the at least two first cells and take it as the second cell, the first condition comprising at least one of the following that:
when a failure of a radio link with its parent IAB-node is detected, the first cell is not a cell of the parent IAB-node;
when the notification of a radio link failure from the parent IAB-node is received, the first cell is not a cell of any IAB-node to which the parent IAB-node is connected; and
when the second indication of flow control from the parent IAB-node is received, the first cell is not a cell of the parent IAB-node;
the second condition comprising at least one of the following that:
the first cell is a cell with a maximum number or a highest proportion of beams or reference signals in S beams or reference signals with best quality;
the first cell with best quality of a beam or a reference signal;
the first cell is a cell with a maximum number or a highest proportion of beams or reference signals in S beams or reference signals with best quality; and
The first cell with T beams or reference signals having best average quality.

13. The apparatus according to claim 1, wherein,
the processor is further configured to apply stored second cell configuration on the selected second cell.

14. The apparatus according to claim 1, wherein,
a CU of an IAB-donor-node of the first IAB-node controls an IAB-MT of the first IAB-node or an IAB-MT of the child IAB-node or the terminal equipment to apply the apparatus for conditional reconfiguration.

15. The apparatus according to claim 1, wherein,
the conditional reconfiguration candidate cells comprise conditional handover candidate cells and/or conditional PSCell change candidate cells.

16. An apparatus for conditional reconfiguration, applicable to a second IAB-node, the second IAB-node being a source parent IAB-node of a first IAB-node,
the apparatus comprising:
a receiver configured to receive a measurement report or a control protocol data unit (PDU) for flow control feedback; and
a processor configured to determine a conditional reconfiguration strategy according to the measurement report or the control protocol data unit.

17. An apparatus for conditional reconfiguration, applicable to a source IAB-donor-node of a first IAB-node,
the apparatus comprising:
a receiver configured to receive a measurement report or a control protocol data unit for flow control feedback or a downlink data transmission state protocol data unit or a notification of a radio link failure; and
a processor configured to determine a conditional reconfiguration strategy according to the measurement report or the control protocol data unit for flow control feedback or the downlink data transmission state protocol data unit or the notification of a radio link failure.

18. The apparatus according to claim 17, wherein,
the control protocol data unit is from an IAB-MT of the first IAB-node or an IAB-MT of a child IAB-node of the first IAB-node.

19. The apparatus according to claim 17, wherein,
the downlink data transmission state protocol data unit is from a parent IAB-node of the first IAB-node or an access IAB-node of a terminal equipment served by the first IAB-node or served by the child IAB-node of the first IAB-node.

20. The apparatus according to claim 17, wherein,
the notification of a radio link failure is from a parent IAB-node of the first IAB-node or an access IAB-node of the terminal equipment served by the first IAB-node or served by the child IAB-node of the first IAB-node.
